(19) United States
(12) Patent Application Publication
(10) Pub. No.: US 2026/0186274 A1
(43) Pub. Date: Jul. 2, 2026

(54) Camera Optical Lens

(71) Applicant: Changzhou AAC Raytech Optronics Co., Ltd., Changzhou City (CN)

(72) Inventor: Haichao Peng, Changzhou (CN)

(21) Appl. No.: 19/306,983

(22) Filed: Aug. 21, 2025

Related U.S. Application Data
(63) Continuation of application No. PCT/CN2024/144630, filed on Dec. 31, 2024.

(51) Int. Cl. G02B 13/00; G02B 15/14

(52) U.S. Cl. CPC G02B 13/007; G02B 15/142

(57) ABSTRACT

The present disclosure discloses a camera optical lens including: a first prism with a positive refractive power, a first lens, a second lens, a third lens, a fourth lens and a fifth lens. A reflective surface is disposed between the object-side surface and image-side surface of the first prism. The first, second and third lenses constitute a first lens group. The fourth and fifth lenses constitute a second lens group. The second lens group is adjustably movable along the optical axis of the camera optical lens to switch between a first state and a second state. The camera optical lens achieves its maximum focal length in the first state and minimum focal length in the second state respectively. The camera optical lens satisfies the following condition: 4.00≤fA/IH≤4.80. The camera optical lens enables a periscope design with a large aperture and provides good optical performance.

### CROSS-REFERENCE TO RELATED APPLICATIONS

This application claims the priority benefit of PCT Patent Application Ser. No. PCT/CN2024/144630 filed on Dec. 31, 2024, the entire content of which is incorporated herein by reference.

### FIELD OF THE PRESENT DISCLOSURE

The present disclosure relates to optical technology, in particular to a camera optical lens.

### DESCRIPTION OF RELATED ART

With the rapid development and widespread adoption of smartphones, the research and design of camera modules have advanced swiftly. Coupled with the current trend in electronic products favoring excellent functionality in a compact and lightweight form factor, miniaturized cameras capable of delivering high imaging quality have become the mainstream in the market.

Telephoto cameras can meet consumer demand for capturing specific subjects. Traditional telephoto cameras suffer from excessive optical track length, which conflicts with the slim design requirements of smartphones. In contrast, the periscope telephoto camera design significantly shortens the optical track length of camera optical lenses while fulfilling telephoto requirements. However, the optical performance of existing periscope telephoto camera lenses still falls short of meeting the requirements.

### SUMMARY

It is an object of the embodiments of the present disclosure to provide a camera optical lens capable of satisfying internal focusing, achieving a large-aperture periscope-type design, and exhibiting excellent optical performance.

In order to overcome shortcomings in the prior art, the present disclosure provides a camera optical lens including, in an order from an object side to an image side in sequence: a first prism with a positive refractive power, a first lens, a second lens, a third lens, a fourth lens, and a fifth lens; wherein a reflective surface is disposed between the object side surface and the image side surface of the first prism, the first lens, the second lens, and the third lens are defined as a first lens group, while the fourth lens and the fifth lens are defined as a second lens group, the second lens group is adjustably movable along the optical axis of the camera optical lens to switch the camera optical lens between a first state and a second state, the camera optical lens achieves its maximum focal length in the first state, and achieves its minimum focal length in the second state; and the camera optical lens further satisfies the following conditions: 4.00≤fA/IH≤4.80, −4.00≤Rp1/Rp2≤1.20, −1.76≤f1/fA≤1.00, and 0.12≤BF/TTL≤0.35, where fA represents a focal length of the camera optical lens in the first state, IH represents an image height of the camera optical lens, Rp1 represents a curvature radius of the object side surface of the first prism, Rp2 represents a curvature radius of the image side surface of the first prism, f1 represents a focal length of the first lens, BF: the back focal length of the camera optical lens, and TTL represents a total optical length of the camera optical lens.

As an improvement, the camera optical lens further satisfies the following conditions: −16.00≤f4/f5≤13.00, where f4 represents a focal length of the fourth lens, and f5: the focal length of the fifth lens.

As an improvement, an object side surface of the first lens is convex in the paraxial region, and the camera optical lens further satisfies the following conditions: 3.09≤fp1/fA≤40.78, and 0.28≤dp1/TTL≤0.38, where fp1 represents a focal length of the first prism, and dp1 represents a sum of the distance on-axis from the object side surface of the first prism to the reflective surface, and the distance on-axis from the reflective surface to the image side surface of the first prism.

As an improvement, an object side surface of the first lens is convex in the paraxial region, and the camera optical lens further satisfies the following conditions: −2.72≤(R1+R2)/(R1−R2)≤5.45, and 0.03≤d1/TTL≤0.14, where R1 represents a curvature radius of the object side surface of the first lens; R2 represents a curvature radius of the image side surface of the first lens, and d1 represents an on-axial thickness of the first lens.

As an improvement, an object side surface of the second lens is convex in the paraxial region, and the camera optical lens further satisfies the following conditions: −1.21≤(R3+R4)/(R3−R4)≤4.65, −1.08≤f2/fA≤0.37, and 0.01≤d3/TTL≤0.07, where R3 represents a curvature radius of the object side surface of the second lens, R4 represents a curvature radius of the image side surface of the second lens, and f2 represents a focal length of the second lens, and d3 represents an on-axis thickness of the second lens.

As an improvement, an object side surface of the third lens is convex in the paraxial region, and the camera optical lens further satisfies the following conditions: −2.27≤(R5+R6)/(R5−R6)≤4.31, −0.99≤f3/fA≤0.98, and 0.01≤d5/TTL≤0.08, where R5 represents a curvature radius of the object side surface of the third lens; R6 represents a curvature radius of the image side surface of the third lens, and f3 represents a focal length of the third lens, and d5 represents an on-axis thickness of the third lens.

As an improvement, an object side surface of the fourth lens is concave in the paraxial region, an image side surface of the fourth lens is convex in the paraxial region, and the camera optical lens further satisfies the following conditions: −7.49≤(R7+R8)/(R7−R8)≤127.20, −10.12≤f4/fA≤10.18, and 0.06≤d7/TTL≤0.15, where R7 represents a curvature radius of the object side surface of the fourth lens, R8 represents a curvature radius of the image side surface of the fourth lens, f4 represents a focal length of the fourth lens, and d7 represents an on-axis thickness of the fourth lens.

As an improvement, an object side surface of the fifth lens is convex in the paraxial region, an image side surface of the fourth lens is concave in the paraxial region, and the camera optical lens further satisfies the following conditions: −59.80≤(R9+R10)/(R9−R10)≤19.69, −12.59≤f5/fA≤12.10, and 0.02≤d9/TTL≤0.16, where R9 represents a curvature radius of the object side surface of the fifth lens, R10 represents a curvature radius of the image side surface of the fifth lens, f5 represents a focal length of the fifth lens, and d9 represents an on-axis thickness of the fifth lens.

As an improvement, the first prism is made of glass material.

### BRIEF DESCRIPTION OF THE DRAWINGS

To more clearly illustrate the technical solutions in the embodiments of the present disclosure, a brief introduction to the accompanying drawings used in the description of the embodiments will be provided below. Obviously, the drawings in the following description are merely some embodiments of the present disclosure, and for those of ordinary skill in the art, without creative efforts, other drawings may be derived from these drawings.

FIG. 1a is a schematic structural diagram of a camera optical lens in accordance with a first embodiment of the present disclosure in a first state;

FIG. 1b is a schematic structural diagram of a camera optical lens in accordance with a first embodiment of the present disclosure in a second state;

FIG. 2a presents a schematic diagram of the field curvature and distortion of the camera optical lens shown in FIG. 1a;

FIG. 2b presents a schematic diagram of the field curvature and distortion of the camera optical lens shown in FIG. 1b;

FIG. 3a shows the longitudinal aberration of the camera optical lens shown in FIG. 1a;

FIG. 3b shows the longitudinal aberration of the camera optical lens shown in FIG. 1b;

FIG. 4a shows the lateral color of the camera optical lens shown in FIG. 1a;

FIG. 4b shows the lateral color of the camera optical lens shown in FIG. 1b;

FIG. 5a is a schematic structural diagram of a camera optical lens in accordance with a second embodiment of the present disclosure in a first state;

FIG. 5b is a schematic structural diagram of a camera optical lens in accordance with a second embodiment of the present disclosure in a second state;

FIG. 6a presents a schematic diagram of the field curvature and distortion of the camera optical lens shown in FIG. 5a;

FIG. 6b presents a schematic diagram of the field curvature and distortion of the camera optical lens shown in FIG. 5b;

FIG. 7a shows the longitudinal aberration of the camera optical lens shown in FIG. 5a;

FIG. 7b shows the longitudinal aberration of the camera optical lens shown in FIG. 5b;

FIG. 8a shows the lateral color of the camera optical lens shown in FIG. 5a;

FIG. 8b shows the lateral color of the camera optical lens shown in FIG. 5b;

FIG. 9a is a schematic structural diagram of a camera optical lens in accordance with a third embodiment of the present disclosure in a first state;

FIG. 9b is a schematic structural diagram of a camera optical lens in accordance with a third embodiment of the present disclosure in a second state;

FIG. 10a presents a schematic diagram of the field curvature and distortion of the camera optical lens shown in FIG. 9a;

FIG. 10b presents a schematic diagram of the field curvature and distortion of the camera optical lens shown in FIG. 9b;

FIG. 11a shows the longitudinal aberration of the camera optical lens shown in FIG. 9a;

FIG. 11b shows the longitudinal aberration of the camera optical lens shown in FIG. 9b;

FIG. 12a shows the lateral color of the camera optical lens shown in FIG. 9a;

FIG. 12b shows the lateral color of the camera optical lens shown in FIG. 9b;

FIG. 13a is a schematic structural diagram of a camera optical lens in accordance with a fourth embodiment of the present disclosure in a first state;

FIG. 13b is a schematic structural diagram of a camera optical lens in accordance with a fourth embodiment of the present disclosure in a second state;

FIG. 14a presents a schematic diagram of the field curvature and distortion of the camera optical lens shown in FIG. 13a;

FIG. 14b presents a schematic diagram of the field curvature and distortion of the camera optical lens shown in FIG. 13b;

FIG. 15a shows the longitudinal aberration of the camera optical lens shown in FIG. 13a;

FIG. 15b shows the longitudinal aberration of the camera optical lens shown in FIG. 13b;

FIG. 16a shows the lateral color of the camera optical lens shown in FIG. 13a;

FIG. 16b shows the lateral color of the camera optical lens shown in FIG. 13b;

FIG. 17a is a schematic structural diagram of a camera optical lens in accordance with a fifth embodiment of the present disclosure in a first state;

FIG. 17b is a schematic structural diagram of a camera optical lens in accordance with a fifth embodiment of the present disclosure in a second state;

FIG. 18a presents a schematic diagram of the field curvature and distortion of the camera optical lens shown in FIG. 17a;

FIG. 18b presents a schematic diagram of the field curvature and distortion of the camera optical lens shown in FIG. 17b;

FIG. 19a shows the longitudinal aberration of the camera optical lens shown in FIG. 17a;

FIG. 19b shows the longitudinal aberration of the camera optical lens shown in FIG. 17b;

FIG. 20a shows the lateral color of the camera optical lens shown in FIG. 17a;

FIG. 20b shows the lateral color of the camera optical lens shown in FIG. 17b;

FIG. 21a is a schematic structural diagram of a camera optical lens in accordance with a sixth embodiment of the present disclosure in a first state;

FIG. 21b is a schematic structural diagram of a camera optical lens in accordance with a sixth embodiment of the present disclosure in a second state;

FIG. 22a presents a schematic diagram of the field curvature and distortion of the camera optical lens shown in FIG. 21a;

FIG. 22b presents a schematic diagram of the field curvature and distortion of the camera optical lens shown in FIG. 21b;

FIG. 23a shows the longitudinal aberration of the camera optical lens shown in FIG. 21a;

FIG. 23b shows the longitudinal aberration of the camera optical lens shown in FIG. 21b;

FIG. 24a shows the lateral color of the camera optical lens shown in FIG. 21a;

FIG. 24b shows the lateral color of the camera optical lens shown in FIG. 21b;

FIG. 25a is a schematic structural diagram of a camera optical lens in accordance with a seventh embodiment of the present disclosure in a first state;

FIG. 25b is a schematic structural diagram of a camera optical lens in accordance with a seventh embodiment of the present disclosure in a second state;

FIG. 26a presents a schematic diagram of the field curvature and distortion of the camera optical lens shown in FIG. 25a;

FIG. 26b presents a schematic diagram of the field curvature and distortion of the camera optical lens shown in FIG. 25b;

FIG. 27a shows the longitudinal aberration of the camera optical lens shown in FIG. 25a;

FIG. 27b shows the longitudinal aberration of the camera optical lens shown in FIG. 25b;

FIG. 28a shows the lateral color of the camera optical lens shown in FIG. 25a;

FIG. 28b shows the lateral color of the camera optical lens shown in FIG. 25b;

FIG. 29a is a schematic structural diagram of a camera optical lens in accordance with an eighth embodiment of the present disclosure in a first state;

FIG. 29b is a schematic structural diagram of a camera optical lens in accordance with an eighth embodiment of the present disclosure in a second state;

FIG. 30a presents a schematic diagram of the field curvature and distortion of the camera optical lens shown in FIG. 29a;

FIG. 30b presents a schematic diagram of the field curvature and distortion of the camera optical lens shown in FIG. 29b;

FIG. 31a shows the longitudinal aberration of the camera optical lens shown in FIG. 29a;

FIG. 31b shows the longitudinal aberration of the camera optical lens shown in FIG. 29b;

FIG. 32a shows the lateral color of the camera optical lens shown in FIG. 29a;

FIG. 32b shows the lateral color of the camera optical lens shown in FIG. 29b;

FIG. 33a is a schematic structural diagram of a camera optical lens in accordance with a ninth embodiment of the present disclosure in a first state;

FIG. 33b is a schematic structural diagram of a camera optical lens in accordance with a ninth embodiment of the present disclosure in a second state;

FIG. 34a presents a schematic diagram of the field curvature and distortion of the camera optical lens shown in FIG. 33a;

FIG. 34b presents a schematic diagram of the field curvature and distortion of the camera optical lens shown in FIG. 33b;

FIG. 35a shows the longitudinal aberration of the camera optical lens shown in FIG. 33a;

FIG. 35b shows the longitudinal aberration of the camera optical lens shown in FIG. 33b;

FIG. 36a shows the lateral color of the camera optical lens shown in FIG. 33a;

FIG. 36b shows the lateral color of the camera optical lens shown in FIG. 33b;

FIG. 37a is a schematic structural diagram of a camera optical lens in accordance with a tenth embodiment of the present disclosure in a first state;

FIG. 37b is a schematic structural diagram of a camera optical lens in accordance with a tenth embodiment of the present disclosure in a second state;

FIG. 38a presents a schematic diagram of the field curvature and distortion of the camera optical lens shown in FIG. 37a;

FIG. 38b presents a schematic diagram of the field curvature and distortion of the camera optical lens shown in FIG. 37b;

FIG. 39a shows the longitudinal aberration of the camera optical lens shown in FIG. 37a;

FIG. 39b shows the longitudinal aberration of the camera optical lens shown in FIG. 37b;

FIG. 40a shows the lateral color of the camera optical lens shown in FIG. 37a;

FIG. 40b shows the lateral color of the camera optical lens shown in FIG. 37b.

### DETAILED DESCRIPTION OF THE EXEMPLARY EMBODIMENTS

To make the objectives, technical solutions, and advantages of the embodiments of the present disclosure clearer, the embodiments of the present disclosure will be described in detail below with reference to the accompanying drawings. However, it should be understood by those of ordinary skill in the art that in the embodiments of the present disclosure, many technical details are set forth to enable readers to better understand the present disclosure. Nevertheless, the technical solutions claimed in the present disclosure may be implemented even without these technical details and various variations and modifications based on the following embodiments.

With reference to the accompanying drawings, the present disclosure provides camera optical lenses 10, 20, 30, 40, 50, 60, 70, 80, 90 and 100. The camera optical lenses 10, 20, 30, 40, 50, 60, 70, 80, 90 and 100 each includes, in an order from the object side to the image side in sequence: a first prism P1 with a positive refractive power, a first lens L1, a second lens L2, a third lens L3, a fourth lens L4, and a fifth lens L5.

A reflective surface is disposed between the object side surface and the image side surface of the first prism P1. The first lens L1, the second lens L2, and the third lens L3 are defined as a first lens group, while the fourth lens L4 and the fifth lens L5 are defined as a second lens group. The second lens group is adjustably movable along the optical axis of the camera optical lenses 10, 20, 30, 40, 50, 60, 70, 80, 90 and 100 to switch the camera optical lenses 10, 20, 30, 40, 50, 60, 70, 80, 90 and 100 between a first state and a second state. The camera optical lenses 10, 20, 30, 40, 50, 60, 70, 80, 90 and 100 achieve their maximum focal length in the first state. The camera optical lenses 10, 20, 30, 40, 50, 60, 70, 80, 90 and 100 achieve their minimum focal length in the second state.

The focal length of the camera optical lenses 10, 20, 30, 40, 50, 60, 70, 80, 90 and 100 in the first state is defined as fA, the image height of the camera optical lenses 10, 20, 30, 40, 50, 60, 70, 80, 90 and 100 is defined as IH, the curvature radius of the object side surface of the first prism P1 is defined as Rp1, the curvature radius of the image side surface of the first prism P1 is defined as Rp2, the focal length of the first lens L1 is defined as f1, the back focal length of the camera optical lenses 10, 20, 30, 40, 50, 60, 70, 80, 90 and 100 is defined as BF, the total optical length of the camera optical lenses 10, 20, 30, 40, 50, 60, 70, 80, 90 and 100 is defined as TTL. The camera optical lenses 10, 20, 30, 40, 50, 60, 70, 80, 90 and 100 further satisfy the following conditions:

$$4. \leq fA / IH \leq 4.8 ; \qquad ( 1 )$$

$$- 4. \leq Rp 1 / Rp 2 \leq 1.2 ; \qquad ( 2 )$$

$$- 1.76 \leq f 1 / fA \leq 1. ; \qquad ( 3 )$$

$$0.12 \leq BF / TTL \leq 0.35 ; \qquad ( 4 )$$

wherein the camera optical lenses 10, 20, 30, 40, 50, 60, 70, 80, 90 and 100 are periscope-type optical lenses with a five-lens configuration. The lenses 10, 20, 30, 40, 50, 60, 70, 80, 90 and 100 each includes, sequentially arranged from the object side to the image side: a first prism P1, a first lens L1, a second lens L2, a third lens L3, a fourth lens L4, and a fifth lens L5.

The five lenses of the camera optical lenses 10, 20, 30, 40, 50, 60, 70, 80, 90 and 100 are respectively the first lens L1, the second lens L2, the third lens L3, the fourth lens L4, and the fifth lens L5. The five lenses are divided into two groups (the first three lenses form a front group, and the last two lenses form a rear group), namely a first lens group and a second lens group. The first lens group is closer to the object side than the second lens group.

The first lens group is the front group. The first lens group includes the first lens L1, the second lens L2, and the third lens L3. The object side surface of the first lens group is the object side surface of the first lens L1, and the image side surface of the first lens group is the image side surface of the third lens L3. The second lens group is the rear group. The second lens group includes the fourth lens L4 and the fifth lens L5. The object side surface of the second lens group is the object side surface of the fourth lens L4, and the image side surface of the second lens group is the image side surface of the fifth lens L5. The rear group including the fourth lens L4 and the fifth lens L5 is movable for focusing. This enables faster and smoother focusing while contributing to controlling the breathing effect.

The first lens group is located between the first prism P1 and the second lens group. The second lens group is movable along the optical axis of the camera optical lenses 10, 20, 30, 40, 50, 60, 70, 80, 90 and 100, enabling adjustment of the distance on-axis from the image side surface of the third lens L3 to the object side surface of the second lens group. Thus, the second lens group functions as a movable zoom group, while the first lens group serves as a fixed-focal-length group. Through movement of the second lens group, the focal length of the camera optical lenses 10, 20, 30, 40, 50, 60, 70, 80, 90 and 100 can be varied, ensuring optimal imaging performance in both a first state and a second state of the camera optical lenses 10, 20, 30, 40, 50, 60, 70, 80, 90 and 100. Specifically, the first state refers to the state where the focal length of the camera optical lenses 10, 20, 30, 40, 50, 60, 70, 80, 90 and 100 is maximized. The second state refers to the state where the focal length of the camera optical lenses 10, 20, 30, 40, 50, 60, 70, 80, 90 and 100 is minimized. For example, the first state may correspond to a telephoto state or a state with the object distance at infinity; the second state may correspond to a short-focus state, a macro state, or a state with an object distance of 200 mm. In this way, the camera optical lenses 10, 20, 30, 40, 50, 60, 70, 80, 90 and 100 focus through the movement of the rear group, the camera optical lenses 10, 20, 30, 40, 50, 60, 70, 80, 90 and 100 thereby achieve an internal focusing method.

Conditional expression (1) defines the ratio of the focal length in the first state (fA) to the image height for the camera optical lenses 10, 20, 30, 40, 50, 60, 70, 80, 90 and 100 (IH). Within the range limited by conditional expression (1), the camera optical lenses 10, 20, 30, 40, 50, 60, 70, 80, 90 and 100 exhibit a longer focal length under a fixed image height IH, which contributes to enhancing the magnification of the camera optical lenses 10, 20, 30, 40, 50, 60, 70, 80, 90 and 100.

Conditional expression (2) defines the ratio range between the curvature radius of the object side surface of the first prism P1 (Rp1) and the curvature radius of the image side surface of the first prism P1 (Rp2). By constraining the shapes of the object side and image side surfaces of the first prism P1 within the range limited by conditional expression (2), it helps mitigate the deflection degree of incident light rays at the prism surfaces, thereby facilitating smoother subsequent light propagation.

Conditional expression (3) defines the ratio range between the focal length of the first lens L1 (f1) and the focal length of the camera optical lenses 10, 20, 30, 40, 50, 60, 70, 80, 90 and 100 in the first state (fA). Through rational allocation of the optical power distribution of the camera optical lenses 10, 20, 30, 40, 50, 60, 70, 80, 90 and 100 within the range limited by conditional expression (3), the camera optical lenses 10, 20, 30, 40, 50, 60, 70, 80, 90 and 100 achieve enhanced imaging quality and reduced sensitivity.

Conditional expression (4) defines the ratio range between the back focal length (BF) and the total optical length of the camera optical lenses 10, 20, 30, 40, 50, 60, 70, 80, 90 and 100 (TTL). By constraining the back focal length within the range limited by conditional expression (4), a longer back focal length is achieved while maintaining miniaturization, thereby facilitating module assembly. Simultaneously, the total focal length of the camera optical lenses 10, 20, 30, 40, 50, 60, 70, 80, 90 and 100 is effectively controlled.

Under the condition that the above conditional expressions are satisfied, the five-lens configuration is divided into a first lens group and a second lens group. By moving the second lens group for focusing, an internal focusing mechanism is achieved for the camera optical lenses 10, 20, 30, 40, 50, 60, 70, 80, 90, and 100. Setting the ratio of the focal length of the camera optical lenses 10, 20, 30, 40, 50, 60, 70, 80, 90 and 100 to the image height (fA/IH) enables the camera optical lenses 10, 20, 30, 40, 50, 60, 70, 80, 90 and 100 to exhibit a longer focal length at a fixed image height IH, thereby enhancing magnification. Configuring the concave-convex shape of the first prism P1 mitigates the deflection degree of light passing through it. Rational allocation of the optical power distribution of the camera optical lenses 10, 20, 30, 40, 50, 60, 70, 80, 90 and 100 optimizes imaging quality and reduces sensitivity. Controlling the back focal length of the camera optical lenses 10, 20, 30, 40, 50, 60, 70, 80, 90 and 100 effectively restrains the total optical length of the camera optical lenses 10, 20, 30, 40, 50, 60, 70, 80, 90, and 100.

Based on the aforementioned conditional expressions and achievable functions, the characteristics of each lens are further refined as follows.

As an improvement, the following condition is satisfied:

$$- 16. \leq f 4 / f 5 \leq 13. ; \qquad ( 5 )$$

where the focal length of the fourth lens L4 is defined as f4, and the focal length of the fifth lens L5 is defined as f5.

Conditional expression (5) defines the ratio range between the focal length of the fourth lens L4 (f4) and the focal length of the fifth lens L5 (f5). Within this constraint, rational allocation of the optical power distribution in camera optical lenses 10, 20, 30, 40, 50, 60, 70, 80, 90, and 100 facilitates a smooth transition of light rays and enhances imaging quality.

The object side surface of the first prism P1 is convex in the paraxial region, while its image side surface is concave, convex, or planar in the paraxial region. The object side surface of the first prism P1 may also be configured with other surface distributions.

As an improvement, the following conditions are satisfied:

$$3.09 \leq fp 1 / fA \leq 40.78 ; \qquad ( 6 )$$

$$0.28 \leq dp 1 / TTL \leq 0 \text{.38} ; \qquad ( 7 )$$

where the focal length of the first prism is defined as fp1; and the sum of the distance on-axis from the object side surface of the first prism to the reflective surface, and the distance on-axis from the reflective surface to the image side surface of the first prism is defined as dp1.

Conditional expression (6) defines the ratio range between the focal length of the first prism P1 (fp1) and the focal length of the camera optical lenses 10, 20, 30, 40, 50, 60, 70, 80, 90, and 100 in the first state (fA). Within this range, the optical performance of the camera optical lenses 10, 20, 30, 40, 50, 60, 70, 80, 90, and 100 is enhanced.

Conditional expression (7) defines the ratio range between the sum of the distance on-axis from the object side surface to the reflective surface and the distance on-axis from the reflective surface to the image-side surface of the first prism P1 (dp1), and the optical total track length (TTL) of the camera optical lenses 10, 20, 30, 40, 50, 60, 70, 80, 90, and 100. Within this constraint, it facilitates the miniaturization design of the camera optical lenses 10, 20, 30, 40, 50, 60, 70, 80, 90, and 100.

The first lens L1 has either positive or negative refractive power. The object side surface of the first lens L1 is convex in the paraxial region, while the image side surface is concave or convex in the paraxial region. The object side surface of the first lens L1 may also be configured as a concave surface.

As an improvement, the following conditions are satisfied:

$$- 2.72 \leq ( R 1 + R 2 ) / ( R 1 - R 2 ) \leq 5.45 ; \qquad ( 8 )$$

$$0.03 \leq d 1 / TTL \leq 0 \text{.14} ; \qquad ( 9 )$$

where the curvature radius of the object side surface of the first lens L1 is defined as R1, the curvature radius of the image side surface of the first lens L1 is defined as R2, and the thickness on-axis of the first lens L1 is defined as d1.

Conditional expression (8) defines the shape of the first lens L1. Within this constraint, rational control of the shape of the first lens L1 enables effective correction of spherical aberration in the system.

Conditional expression (9) defines the ratio range between the thickness on-axis of the first lens L1 (d1) and the optical total track length (TTL) of camera optical lenses 10, 20, 30, 40, 50, 60, 70, 80, 90, and 100. Within the range limited by conditional expression (9), it facilitates miniaturized design.

The second lens L2 has either positive or negative refractive power. The object side surface of the second lens L2 is convex in the paraxial region, while the image side surface of the second lens L2 is concave or convex in the paraxial region. The object side surface of the second lens L2 may also be configured as a concave surface.

As an improvement, the following conditions are satisfied:

$$- 1.21 \leq ( R 3 + R 4 ) / ( R 3 - R 4 ) \leq 4.65 ; \qquad ( 10 )$$

$$- 1.08 \leq f 2 / fA \leq 0.37 ; \qquad ( 11 )$$

$$0.01 \leq d 3 / TTL \leq 0 \text{.07} ; \qquad ( 12 )$$

where the curvature radius of the object side surface of the second lens L2 is defined as R3, the curvature radius of the image side surface of the second lens L2 is defined as R4, the focal length of the second lens L2 is defined as f2, and the thickness on-axis of the second lens L2 is defined as d3.

Conditional expression (10) defines the shape of the second lens L2. Rational control of the shape of the second lens L2 within this constraint facilitates its manufacturability, mitigates light deflection through the lens, and effectively reduces aberrations.

Conditional expression (11) defines the ratio range between the focal length of the second lens L2 (f2) and the focal length of camera optical lenses 10, 20, 30, 40, 50, 60, 70, 80, 90, and 100 in the first state (fA). Within this range, rational allocation of optical power optimizes imaging quality and reduces system sensitivity.

Conditional expression (12) defines the ratio range between the thickness on-axis of the second lens L2 (d3) and the total optical length (TTL) of the camera optical lenses 10, 20, 30, 40, 50, 60, 70, 80, 90, and 100. Compliance with this expression facilitates miniaturized design.

The third lens L3 has either positive or negative refractive power. The object side surface of the third lens L3 is convex in the paraxial region, while the image side surface of the third lens L3 is concave or convex in the paraxial region. The object side surface of the third lens L3 may also be configured as a concave surface.

As an improvement, the following conditions are satisfied:

$$- 2.27 \leq ( R 5 + R 6 ) / ( R 5 - R 6 ) \leq 4.31 ; \qquad ( 13 )$$

$$- 0.9 \; 9 \leq f 3 / fA \leq 0.98 ; \qquad ( 14 )$$

$$0.01 \leq d 5 / TTL \leq 0 \text{.08} ; \qquad ( 15 )$$

where the curvature radius of the object side surface of the third lens L3 is defined as R5, the curvature radius of the image side surface of the third lens L3 is defined as R6, the focal length of the third lens L3 is defined as f3, and the thickness on-axis of the third lens L3 is defined as d5.

Conditional expression (13) defines the shape of the third lens L3. Within this constraint, the progression toward miniaturization of camera optical lenses 10, 20, 30, 40, 50, 60, 70, 80, 90, and 100 facilitates effective correction of on-axis chromatic aberration.

Conditional expression (14) limits the ratio range between the focal length of the third lens L3 (f3) and the focal length of the camera optical lenses 10, 20, 30, 40, 50, 60, 70, 80, 90, and 100 in the first state (fA). Compliance with this expression enhances the optical performance of the lenses.

Conditional expression (15) defines the ratio range between the thickness on-axis of the third lens L3 (d5) and the total optical length of camera optical lenses 10, 20, 30, 40, 50, 60, 70, 80, 90, and 100 (TTL). Adherence to this parameter range contributes to the miniaturized design of the lenses.

The fourth lens L4 has either positive or negative refractive power. The object side surface of the fourth lens L4 is concave in the paraxial region, while the image side surface of the fourth lens L4 is convex in the paraxial region. The object side and image side surfaces of the fourth lens L4 may also be configured with other concave/convex distributions.

As an improvement, the following conditions are satisfied:

$$- 7.49 \leq ( R 7 + R 8 ) / ( R 7 - R 8 ) \leq 127 \text{.20} ; \qquad ( 16 )$$

$$- 10. 12 \leq f 4 / fA \leq 10 \text{.18} ; \qquad ( 17 )$$

$$0.06 \leq d 7 / TTL \leq 0.15 ; \qquad ( 18 )$$

where the curvature radius of the object side surface of the fourth lens L4 is defined as R7, the curvature radius of the image side surface of the fourth lens L4 is defined as R8, the focal length of the fourth lens L4 is defined as f4, and the thickness on-axis of the fourth lens L4 is defined as d7.

Conditional expression (16) defines the shape of the fourth lens L4. Within the constraint range of this expression, rational control over the shape of the fourth lens L4 enables effective correction of spherical aberration in the system.

Conditional expression (17) limits the ratio range between the focal length of the fourth lens L4 (f4) and the focal length of the camera optical lenses 10, 20, 30, 40, 50, 60, 70, 80, 90, and 100 in the first state (fA). Compliance with this range facilitates smoothing of ray angles in the lenses, thereby reducing sensitivity to manufacturing tolerances.

Conditional expression (18) defines the ratio range between the thickness on-axis of the fourth lens L4 (d7) and the total optical length of the camera optical lenses 10, 20, 30, 40, 50, 60, 70, 80, 90, and 100 (TTL). Adherence to this parameter range contributes to the miniaturized design of the lenses.

The fifth lens L5 has either positive or negative refractive power. The object side surface of the fifth lens L5 is convex in the paraxial region, while the image side surface of the fifth lens L5 is concave in the paraxial region. The object side and image side surfaces of the fifth lens L5 may also be configured with other concave/convex distributions.

As an improvement, the following conditions are satisfied:

$$- 59.80 \leq ( R 9 + R 10 ) / ( R 9 - R 10 ) \leq 19.69 ; \qquad ( 19 )$$

$$- 12. 59 \leq f 5 / fA \leq 12 \text{.10} ; \qquad ( 20 )$$

$$0.02 \leq d 9 / TTL \leq 0 \text{.16} ; \qquad ( 21 )$$

where the curvature radius of the object side surface of the fifth lens L5 is defined as R9, the curvature radius of the image side surface of the fifth lens L5 is defined as R10, the focal length of the fifth lens L5 is defined as f5, and the thickness on-axis of the fifth lens L5 is defined as d9.

Conditional expression (19) defines the shape of the fifth lens L5. Within this constraint range, the progression toward miniaturization of the camera optical lenses 10, 20, 30, 40, 50, 60, 70, 80, 90, and 100 facilitates effective correction of on-axis chromatic aberration.

Conditional expression (20) limits the ratio range between the focal length of the fifth lens L5 (f5) and the focal length of camera optical lenses 10, 20, 30, 40, 50, 60, 70, 80, 90, and 100 in the first state (fA). Compliance with this range optimizes optical power distribution, enabling the system to achieve superior imaging quality and reduced sensitivity to manufacturing tolerances.

Conditional expression (21) defines the ratio between the thickness on-axis of the fifth lens L5 (d9) and the total optical length of camera optical lenses 10, 20, 30, 40, 50, 60, 70, 80, 90, and 100 (TTL). Adherence to this parameter contributes to the miniaturized design of the lenses.

In the present disclosure, the material of the first prism P1 is glass, while the materials of the first lens L1, second lens L2, third lens L3, fourth lens L4, and fifth lens L5 are plastic. In other feasible implementations, the first prism P1 and each lens may alternatively be configured with other materials.

In the present disclosure, between the fifth lens L5 and the image plane SI, an optical filter GF may be disposed—which may be a glass cover plate or an optical filter (e.g., spectral filter). In other examples, the optical filter GF may additionally be positioned at alternative locations.

In the present disclosure, an aperture stop S1 is further disposed between the first prism P1 and the first lens L1.

The camera optical lenses 10, 20, 30, 40, 50, 60, 70, 80, 90, and 100 of the present disclosure enable a large-aperture periscope design while maintaining excellent optical performance.

The camera optical lenses 10, 20, 30, 40, 50, 60, 70, 80, 90, and 100 of the present disclosure will be described below with reference to various embodiments. The symbols used in each embodiment are as follows. The focal length, the distance on-axis, the central curvature radius, and the thickness on-axis are expressed in millimeters.

TTL: Total optical length (the distance on-axis from the object side surface of the first prism P1 to the image plane SI), expressed in millimeters.

BF: Back Focal Length (the distance on-axis from the image side surface of the fifth lens L5 to the image plane Si), expressed in millimeters.

The technical solutions of the present disclosure will be specifically described through ten embodiments.

### Embodiment 1

The first prism P1 has a positive refractive power, with its object side surface convex in the paraxial region and its image side surface planar in the paraxial region;

The first lens L1 has a positive refractive power, with its object side surface convex in the paraxial region and its image side surface convex in the paraxial region;

The second lens L2 has a negative refractive power, with its object side surface convex in the paraxial region and its image side surface concave in the paraxial region;

The third lens L3 has a positive refractive power, with its object side surface convex in the paraxial region and its image side surface concave in the paraxial region;

The fourth lens L4 has a positive refractive power, with its object side surface concave in the paraxial region and its image side surface convex in the paraxial region;

The fifth lens L5 has a negative refractive power, with its object side surface convex in the paraxial region and its image side surface concave in the paraxial region.

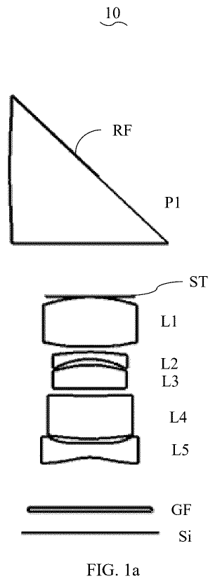

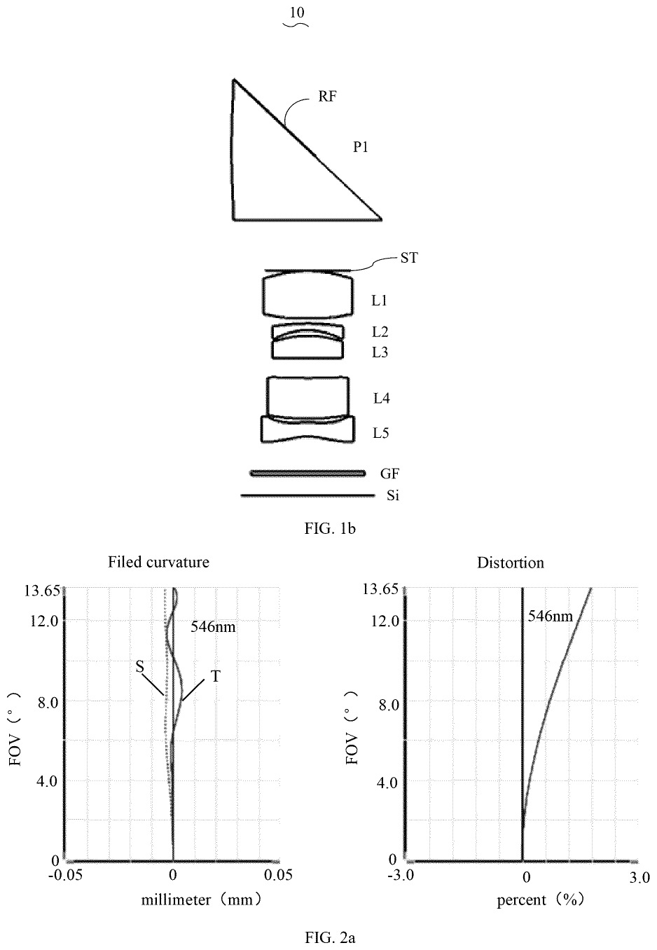

FIGS. 1a and 1b are schematic structural diagrams of the camera optical lens 10 in the first embodiment. The design data of the camera optical lens 10 in the first embodiment are shown below.

Table 1 lists the curvature radius R of the object side and image side surfaces from the first prism P1 to the fifth lens L5 constituting the camera optical lens 10 in the first embodiment of the present disclosure, the thickness on-axis of each lens, the distance on-axis d between adjacent lenses, the refractive index nd, and the Abbe number vd. Note that in this implementation, the units for distance, radius, and thickness are all millimeters (mm).

TABLE 1

| | R | d | | nd | | vd | |
|---|---|---|---|---|---|---|---|
| ST | ∞ | d0 | −12.085 | / | / | / | / |
| Rp1 | 50.431 | dp1 | 8.907 | nd1 | 1.5168 | vd1 | 64.17 |
| Rp2 | ∞ | dp2 | 3.200 | | | | |
| R1 | 6.345 | d1 | 2.965 | nd2 | 1.5444 | vd2 | 55.82 |
| R2 | −36.783 | d2 | 0.325 | | | | |
| R3 | 8.571 | d3 | 0.424 | nd3 | 1.6150 | vd3 | 25.94 |
| R4 | 3.504 | d4 | 0.351 | | | | |
| R5 | 5.235 | d5 | 1.393 | nd4 | 1.5444 | vd4 | 55.82 |
| R6 | 61.894 | d6 | d6 | | | | |
| R7 | −22.503 | d7 | 2.551 | nd5 | 1.6700 | vd5 | 19.39 |
| R8 | −14.176 | d8 | 0.238 | | | | |
| R9 | 9.102 | d9 | 0.882 | nd6 | 1.5444 | vd6 | 55.82 |
| R10 | 3.162 | d10 | d10 | | | | |
| R11 | ∞ | d11 | 0.210 | ndg | 1.5168 | vdg | 64.17 |
| R12 | ∞ | d12 | 1.290 | | | | |

In which, d1=“dp1-01”+“dp1-02”, “dp1-01”=4.510, and “dp1-02”=4.397.

Table 2 shows data of related optical parameters for the camera optical lens 10 according to the first embodiment of the present disclosure in a first state and a second state, respectively.

TABLE 2

| | First state | Second state |
|---|---|---|
| fA | 14.500 | 13.560 |
| FOV | 27.30° | 26.42° |
| FNO | 2.60 | 2.86 |
| d6 | 0.448 | 1.239 |
| d10 | 3.000 | 2.209 |

In which, the meaning of the various symbols is as follows.
R: The curvature radius of the optical surface, the central curvature radius in case of lens;
S1: Aperture;
Rp1: The curvature radius of the object side surface of the first prism P1;
Rp2: The curvature radius of the image side surface of the first prism P1;
R1: The curvature radius of the object side surface of the first lens L1;
R2: The curvature radius of the image side surface of the first lens L1;
R3: The curvature radius of the object side surface of the second lens L2;
R4: The curvature radius of the image side surface of the second lens L2;
R5: The curvature radius of the object side surface of the third lens L3;
R6: The curvature radius of the image side surface of the third lens L3;
R7: The curvature radius of the object side surface of the fourth lens L4;
R8: The curvature radius of the image side surface of the fourth lens L4;
R9: The curvature radius of the object side surface of the fifth lens L5;
R10: The curvature radius of the image side surface of the fifth lens L5;
R11: The curvature radius of the object side surface of the optical filter GF;
R12: The curvature radius of the image side surface of the optical filter GF;
d: The thickness on-axis of the lens and the distance on-axis between the lens;
d0: The distance on-axis from aperture S1 to the object side surface of the first prism P1;
dp1: The sum of the distance on-axis from the object side surface of the first prism P1 to the reflective surface, and the distance on-axis from the reflective surface to the image side surface of the first prism P1;
dp2: The distance on-axis from the image side surface of the first prism P1 to the object side surface of the first lens L1;
d1: The thickness on-axis of the first lens L1;
d2: The distance on-axis from the image side surface of the first lens L1 to the object side surface of the second lens L2;
d3: The thickness on-axis of the second lens L2;
d4: The distance on-axis from the image side surface of the second lens L2 to the object side surface of the third lens L3;
d5: The thickness on-axis of the third lens L3;
d6: The distance on-axis from the image side surface of the third lens L3 to the object side surface of the fourth lens L4;
d7: The thickness on-axis of the fourth lens L4;
d8: The distance on-axis from the image side surface of the fourth lens L4 to the object side surface of the fifth lens L5;
d9: The thickness on-axis of the fifth lens L5;
d10: The distance on-axis from the image side surface of the fifth lens L5 to the object side surface of the optical filter GF;
d11: The thickness on-axis of the optical filter GF;
d12: The distance on-axis from the image side surface of the optical filter GF to the image plane SI;
nd: The refractive power of the d line;
nd1: The refractive power of the d line of the first prism P1;
nd2: The refractive power of the d line of the first lens L1;
nd3: The refractive power of the d line of the second lens L2;
nd4: The refractive power of the d line of the third lens L3;
nd5: The refractive power of the d line of the fourth lens L4;
nd6: The refractive power of the d line of the fifth lens L5;
ndg: The refractive power of the d line of the optical filter GF;
vd: The abbe number;
vd1: The abbe number of the first prism P1;
vd2: The abbe number of the first lens L1;
vd3: The abbe number of the second lens L2;
vd4: The abbe number of the third lens L3;
vd5: The abbe number of the fourth lens L4;
Vd6: The abbe number of the fifth lens L5;
vdg: The abbe number of the optical filter GF.

Table 3 shows the conic index and aspherical surface index of the camera optical lens 10.

TABLE 3

| | Conic Index | Aspherical Surface Index | | | | |
|---|---|---|---|---|---|---|
| | k | A4 | A6 | A8 | A10 | A12 |
| R1 | −6.10148E+01 | −1.66250E−05 | −9.16310E−07 | 1.15930E−08 | 3.10960E−10 | −2.38470E−11 |
| R2 | 0.00000E+00 | 0.00000E+00 | 0.00000E+00 | 0.00000E+00 | 0.00000E+00 | 0.00000E+00 |
| R3 | 2.83949E−01 | −1.05870E−03 | −1.62310E−04 | 4.96970E−05 | −2.40910E−05 | 6.23840E−06 |
| R4 | 1.51875E+02 | −5.13820E−03 | 2.45540E−04 | −4.28790E−05 | 7.74640E−06 | −4.77270E−07 |
| R5 | −5.96573E+01 | 1.90370E−03 | −2.02050E−03 | 1.19070E−03 | −4.17080E−04 | 9.83880E−05 |
| R6 | 1.07300E+00 | −1.33280E−02 | 1.78440E−03 | −4.55960E−04 | 2.86020E−04 | −1.56850E−04 |
| R7 | −1.29583E+01 | 7.89470E−03 | −2.98950E−03 | 1.08370E−03 | −3.00700E−04 | 6.96600E−05 |
| R8 | −1.22353E+02 | 4.07280E−04 | −8.16500E−04 | 3.49020E−04 | −2.27860E−04 | 1.46120E−04 |
| R9 | 1.08257E+01 | 3.95490E−03 | −1.34520E−03 | 1.36180E−03 | −1.01720E−03 | 5.12140E−04 |
| R10 | 6.93513E+00 | −9.10450E−03 | 7.44120E−03 | −3.67450E−03 | 1.34900E−03 | −3.41640E−04 |
| R11 | 6.97685E+00 | −4.95960E−02 | 1.45740E−02 | −5.08880E−03 | 1.55690E−03 | −3.57590E−04 |
| R12 | −6.32336E+00 | −1.86650E−02 | 3.97840E−03 | −5.87210E−04 | 4.70480E−06 | 2.30520E−05 |

| | Conic Index | Aspherical Surface Index | | | |
|---|---|---|---|---|---|
| | k | A14 | A16 | A18 | A20 |
| R1 | −6.10148E+01 | −9.62570E−13 | 4.50260E−14 | 3.51030E−15 | −1.44110E−16 |
| R2 | 0.00000E+00 | 0.00000E+00 | 0.00000E+00 | 0.00000E+00 | 0.00000E+00 |
| R3 | 2.83949E−01 | −1.01770E−06 | 1.00440E−07 | −5.51520E−09 | 1.29010E−10 |
| R4 | 1.51875E+02 | −1.41900E−08 | −7.39770E−10 | 3.50780E−10 | 9.18930E−12 |
| R5 | −5.96573E+01 | −1.57190E−05 | 1.66200E−06 | −1.07490E−07 | 3.30030E−09 |
| R6 | 1.07300E+00 | 4.96120E−05 | −9.43310E−06 | 1.00390E−06 | −4.53670E−08 |
| R7 | −1.29583E+01 | −1.33610E−05 | 1.88120E−06 | −1.56920E−07 | 8.12230E−09 |
| R8 | −1.22353E+02 | −6.46550E−05 | 1.65290E−05 | −2.21030E−06 | 1.20110E−07 |
| R9 | 1.08257E+01 | −1.65800E−04 | 3.27730E−05 | −3.57630E−06 | 1.64580E−07 |
| R10 | 6.93513E+00 | 5.46470E−05 | −5.11990E−06 | 2.50300E−07 | −4.56170E−09 |
| R11 | 6.97685E+00 | 5.36970E−05 | −5.01560E−06 | 2.94850E−07 | −9.58260E−09 |
| R12 | −6.32336E+00 | −6.15550E−06 | 8.20410E−07 | −5.72890E−08 | 1.65160E−09 |

Note that in this embodiment, the aspheric surfaces of each lens are defined by Formula (22) below; however, the specific form of Formula (22) is exemplary only, and the aspheric polynomial form represented by Formula (22) is not limited in practice.

$$z = ( c {r}^{2} ) / \{ 1 + {[ 1 - ( k + 1 ) ( {c}^{2} {r}^{2} ) ]}^{1 / 2} \} + A 4 {r}^{4} + A 6 {r}^{6} + A 8 {r}^{8} + A 10 {r}^{10} + A 12 {r}^{12} + A 14 {r}^{14} + A 16 {r}^{16} + A 18 {r}^{18} + A 20 {r}^{20} \qquad ( 22 )$$

Among them, K is a conic index, A4, A6, A8, A10, A12, A14, A16, A18, A20 are aspheric surface indexes, c is the curvature at the center of the optical surface, r is the vertical distance from the optical axis to a point on the aspheric curve, and z is the sagitta (i.e., the vertical distance between a point on the aspheric surface at distance r from the optical axis and a plane tangent to the vertex of the aspheric surface on the optical axis).

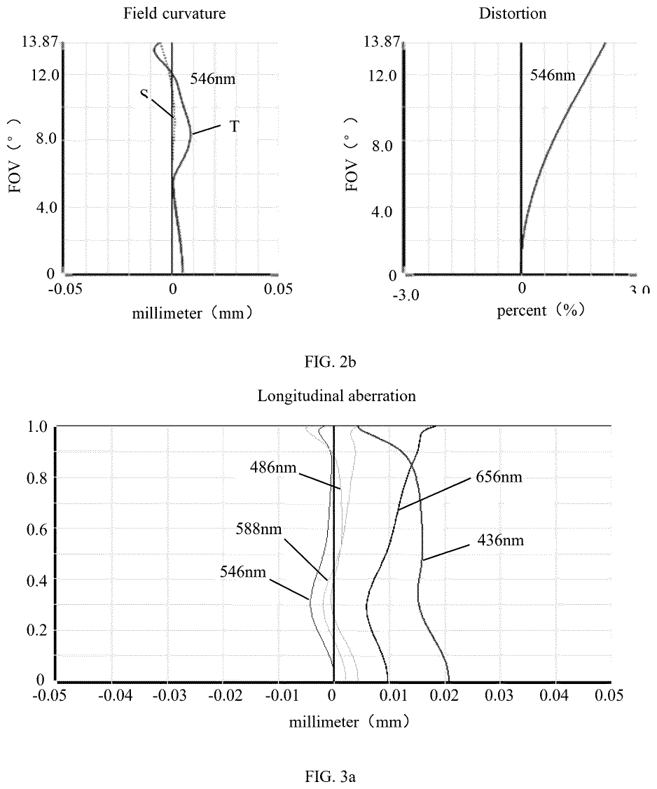

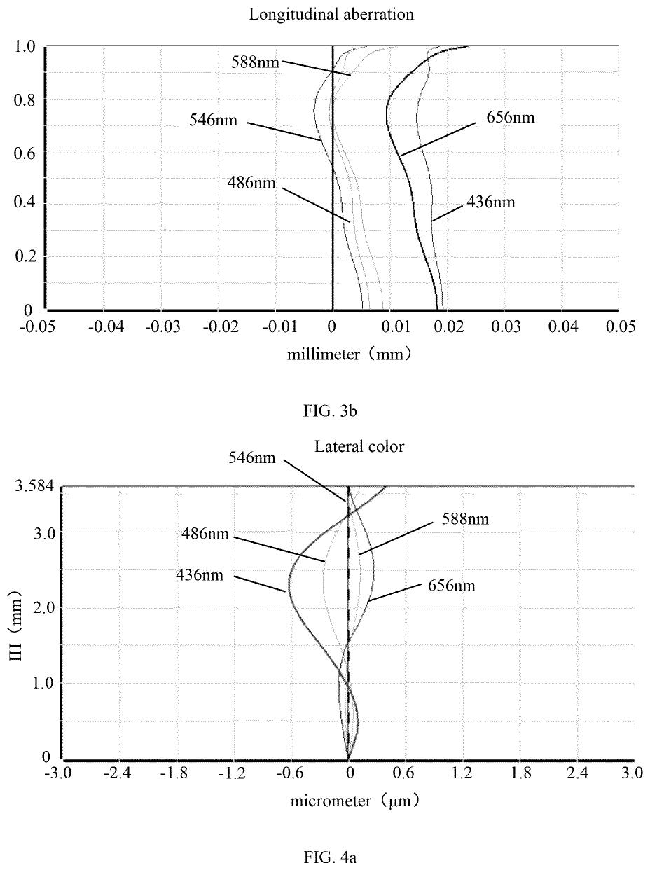

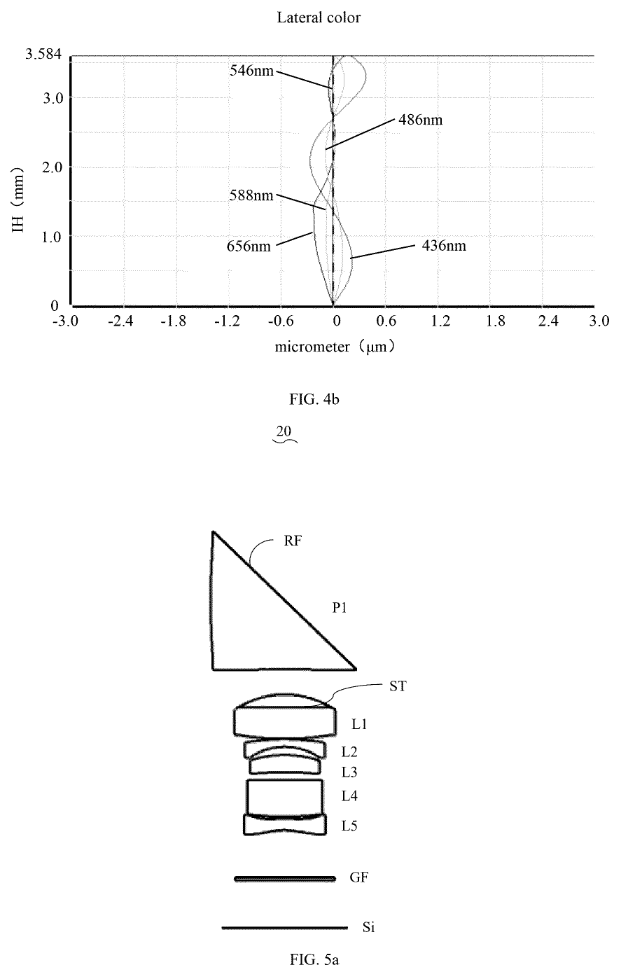

FIG. 2a and FIG. 2b show the field curvature and distortion schematic diagrams after light with a wavelength of 546 nm passes the camera optical lens 10 of the first embodiment. FIG. 3a and FIG. 3b show the longitudinal aberration schematic diagrams after light with a wavelength of 436 nm, 486 nm, 546 nm, 588 nm and 656 nm passes the camera optical lens 10 of the first embodiment. FIG. 4a and FIG. 4b show the lateral color schematic diagrams after light with a wavelength of 436 nm, 486 nm, 546 nm, 588 nm and 656 nm passes the camera optical lens 10 of the first embodiment.

In this embodiment, the entrance pupil diameter (ENPD) of the camera optical lens 10 in the first state is 5.577 mm, the full field image height (IH) is 3.584 mm, and the field of view (FOV) is 27.30°. The camera optical lens 10 enables a large-aperture periscope design, exhibiting superior optical performance with sufficiently corrected on-axis and off-axis chromatic aberrations, and possesses excellent optical characteristics.

### Embodiment 2

The first prism P1 has a positive refractive power, with its object side surface convex in the paraxial region and its image side surface concave in the paraxial region;

The first lens L1 has a positive refractive power, with its object side surface convex in the paraxial region and its image side surface convex in the paraxial region;

The second lens L2 has a negative refractive power, with its object side surface convex in the paraxial region and its image side surface concave in the paraxial region;

The third lens L3 has a positive refractive power, with its object side surface convex in the paraxial region and its image side surface concave in the paraxial region;

The fourth lens L4 has a positive refractive power, with its object side surface concave in the paraxial region and its image side surface convex in the paraxial region;

The fifth lens L5 has a negative refractive power, with its object side surface convex in the paraxial region and its image side surface concave in the paraxial region.

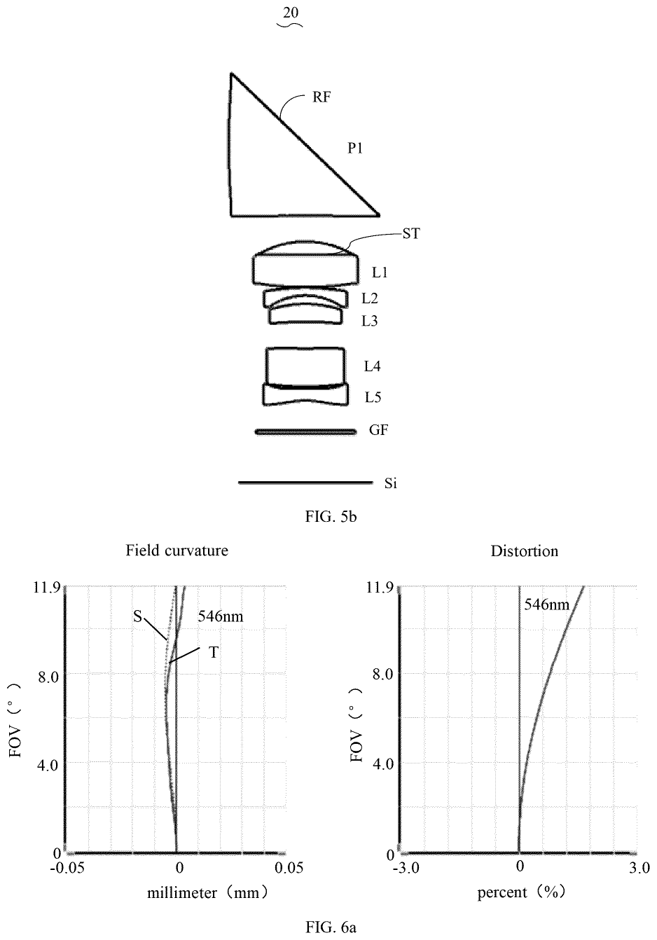

FIGS. 5a and 5b are schematic structural diagrams of the camera optical lens 20 in the second embodiment. The symbol meanings in the second embodiment are the same as those in the first embodiment.

Table 4 shows the design data of the camera optical lens 20 in the second embodiment.

TABLE 4

| | R | d | | nd | | vd | |
|---|---|---|---|---|---|---|---|
| ST | ∞ | d0 | −11.427 | / | / | / | / |
| Rp1 | 43.247 | dp1 | 9.000 | nd1 | 1.5168 | vd1 | 64.17 |
| Rp2 | 123.564 | dp2 | 1.591 | | | | |
| R1 | 5.230 | d1 | 2.803 | nd2 | 1.5444 | vd2 | 55.82 |
| R2 | −42.796 | d2 | 0.050 | | | | |
| R3 | 9.289 | d3 | 0.487 | nd3 | 1.6150 | vd3 | 25.94 |
| R4 | 3.467 | d4 | 0.517 | | | | |
| R5 | 5.718 | d5 | 1.102 | nd4 | 1.5444 | vd4 | 55.82 |
| R6 | 14.755 | d6 | 0.495 | | | | |
| R7 | −46.569 | d7 | 2.360 | nd5 | 1.6700 | vd5 | 19.39 |
| R8 | −16.499 | d8 | 0.116 | | | | |
| R9 | 9.932 | d9 | 0.736 | nd6 | 1.5444 | vd6 | 55.82 |
| R10 | 3.643 | d10 | 3.000 | | | | |
| R11 | ∞ | d11 | 0.210 | ndg | 1.5168 | vdg | 64.17 |
| R12 | ∞ | d12 | 3.039 | | | | |

In which, d1=“dp1-01”+“dp1-02”, “dp1-01”=4.573, and “dp1-02”=4.427.

Table 5 shows data of related optical parameters for the camera optical lens 20 according to the second embodiment of the present disclosure in a first state and a second state, respectively.

TABLE 5

| | First state | Second state |
|---|---|---|
| fA | 16.737 | 15.620 |
| FOV | 23.79° | 22.71° |
| FNO | 2.60 | 2.84 |
| d6 | 0.495 | 1.304 |
| d10 | 3.000 | 2.191 |

Table 6 shows the conic index and aspherical surface index of the camera optical lens 20.

TABLE 6

| | Conic Index | Aspherical Surface Index | | | | |
|---|---|---|---|---|---|---|
| | k | A4 | A6 | A8 | A10 | A12 |
| R1 | −5.34335E+01 | −5.52010E−05 | −2.40060E−06 | 7.84650E−08 | −1.02890E−09 | −1.95330E−10 |
| R2 | 0.00000E+00 | 0.00000E+00 | 0.00000E+00 | 0.00000E+00 | 0.00000E+00 | 0.00000E+00 |
| R3 | 7.24587E−01 | −6.36360E−04 | −1.33550E−04 | 5.07060E−05 | −2.38250E−05 | 6.22540E−06 |
| R4 | 1.14976E+02 | −3.67050E−03 | 3.62390E−04 | −3.92200E−05 | 6.90740E−06 | −5.06760E−07 |
| R5 | −6.85343E+01 | 1.80090E−03 | −2.00280E−03 | 1.19450E−03 | −4.16010E−04 | 9.84460E−05 |
| R6 | 1.07704E+00 | −1.24150E−02 | 1.81790E−03 | −4.49450E−04 | 2.85840E−04 | −1.56950E−04 |
| R7 | −1.76939E+01 | 7.07360E−03 | −2.88830E−03 | 1.13160E−03 | −3.05430E−04 | 6.94780E−05 |
| R8 | −4.88247E+01 | 3.46490E−04 | −8.02620E−04 | 3.75850E−04 | −2.29410E−04 | 1.45980E−04 |
| R9 | 4.64160E+01 | 3.68850E−03 | −1.26540E−03 | 1.33130E−03 | −1.01430E−03 | 5.12900E−04 |
| R10 | −3.83869E+01 | −9.36200E−03 | 7.63740E−03 | −3.76620E−03 | 1.34970E−03 | −3.41030E−04 |
| R11 | 9.66411E+00 | −4.47730E−02 | 1.42290E−02 | −5.15470E−03 | 1.55510E−03 | −3.56830E−04 |
| R12 | −7.26750E+00 | −1.78030E−02 | 3.74950E−03 | −5.61670E−04 | 1.67470E−06 | 2.33620E−05 |

| | Conic Index | Aspherical Surface Index | | | |
|---|---|---|---|---|---|
| | k | A14 | A16 | A18 | A20 |
| R1 | −5.34335E+01 | −5.35870E−13 | 5.52540E−13 | 5.45830E−15 | −8.44290E−16 |
| R2 | 0.00000E+00 | 0.00000E+00 | 0.00000E+00 | 0.00000E+00 | 0.00000E+00 |
| R3 | 7.24587E−01 | −1.01860E−06 | 1.00750E−07 | −5.51390E−09 | 1.27910E−10 |
| R4 | 1.14976E+02 | −3.84590E−09 | −1.16390E−09 | 3.01890E−10 | −2.68030E−12 |
| R5 | −6.85343E+01 | −1.57250E−05 | 1.66040E−06 | −1.07670E−07 | 3.32350E−09 |
| R6 | 1.07704E+00 | 4.95650E−05 | −9.44440E−06 | 1.00220E−06 | −4.54890E−08 |
| R7 | −1.76939E+01 | −1.34310E−05 | 1.86910E−06 | −1.57920E−07 | 8.44150E−09 |
| R8 | −4.88247E+01 | −6.47400E−05 | 1.65260E−05 | −2.20550E−06 | 1.19870E−07 |
| R9 | 4.64160E+01 | −1.65850E−04 | 3.27420E−05 | −3.57700E−06 | 1.65220E−07 |
| R10 | −3.83869E+01 | 5.48050E−05 | −5.10710E−06 | 2.48590E−07 | −4.78410E−09 |
| R11 | 9.66411E+00 | 5.39040E−05 | −4.97980E−06 | 2.97730E−07 | −1.10090E−08 |
| R12 | −7.26750E+00 | −6.10750E−06 | 8.19800E−07 | −5.85030E−08 | 1.70600E−09 |

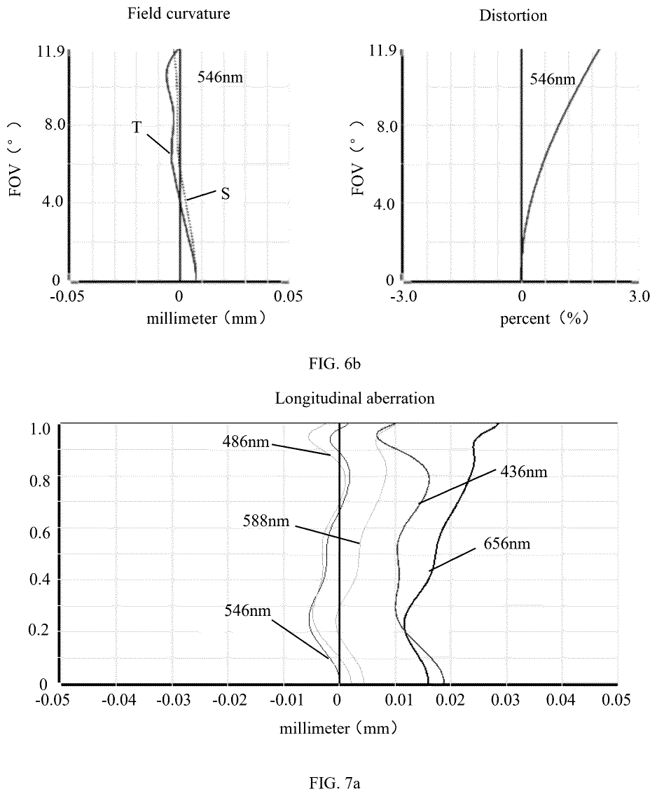

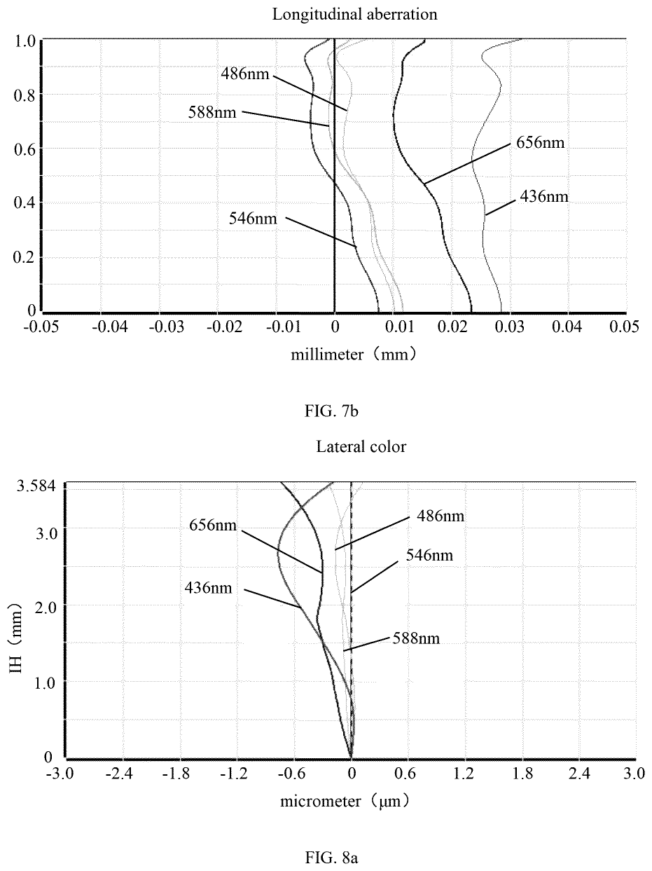

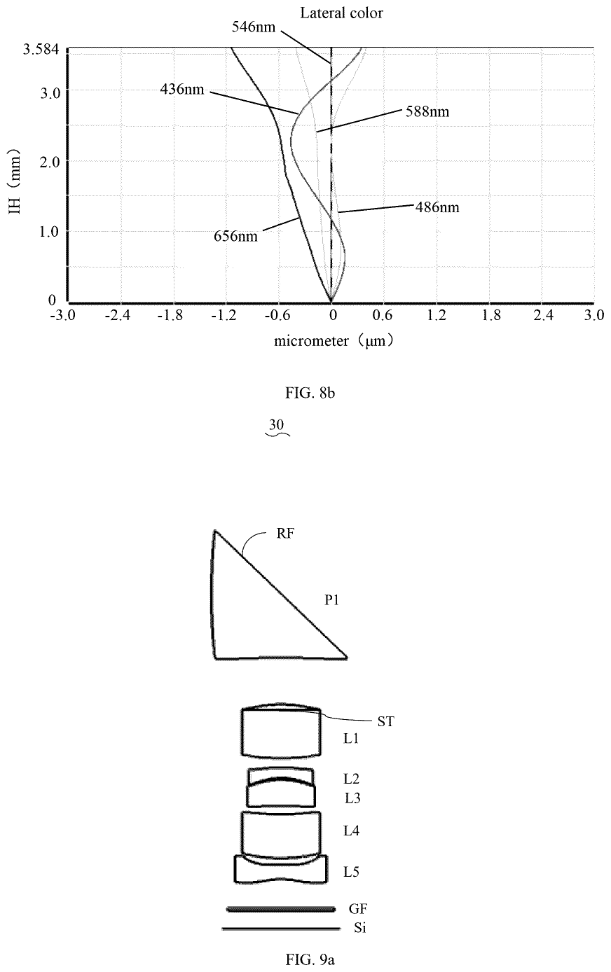

FIG. 6a and FIG. 6b show the field curvature and distortion schematic diagrams after light with a wavelength of 546 nm passes the camera optical lens 20 of the second embodiment. FIG. 7a and FIG. 7b show the longitudinal aberration schematic diagrams after light with a wavelength of 436 nm, 486 nm, 546 nm, 588 nm and 656 nm passes the camera optical lens 20 of the second embodiment. FIG. 8a and FIG. 8b show the lateral color schematic diagrams after light with a wavelength of 436 nm, 486 nm, 546 nm, 588 nm and 656 nm passes the camera optical lens 20 of the second embodiment.

In this embodiment, the entrance pupil diameter (ENPD) of the camera optical lens 20 in the first state is 6.437 mm, the full field image height (IH) is 3.584 mm, and the field of view (FOV) is 23.79°. The camera optical lens 20 enables a large-aperture periscope design, exhibiting superior optical performance with sufficiently corrected on-axis and off-axis chromatic aberrations, and possesses excellent optical characteristics.

### Embodiment 3

The first prism P1 has a positive refractive power, with its object side surface convex in the paraxial region and its image side surface concave in the paraxial region;

The first lens L1 has a positive refractive power, with its object side surface convex in the paraxial region and its image side surface convex in the paraxial region;

The second lens L2 has a negative refractive power, with its object side surface convex in the paraxial region and its image side surface concave in the paraxial region;

The third lens L3 has a positive refractive power, with its object side surface convex in the paraxial region and its image side surface concave in the paraxial region;

The fourth lens L4 has a positive refractive power, with its object side surface concave in the paraxial region and its image side surface convex in the paraxial region;

The fifth lens L5 has a negative refractive power, with its object side surface convex in the paraxial region and its image side surface concave in the paraxial region.

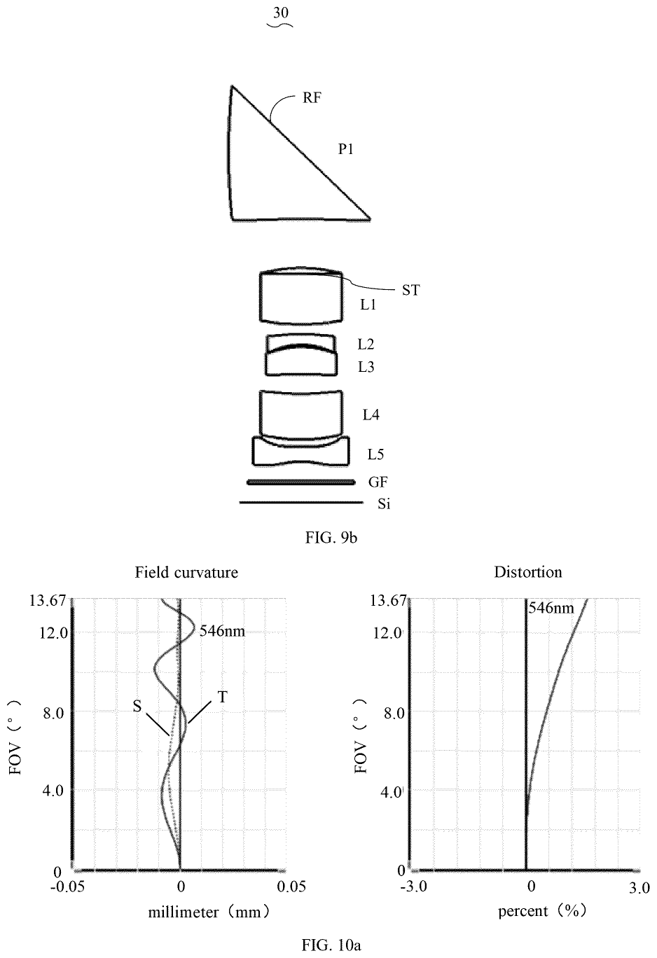

FIGS. 9a and 9b are schematic structural diagrams of the camera optical lens 30 in the third embodiment. The symbol meanings in the third embodiment are the same as those in the first embodiment.

Table 7 shows the design data of the camera optical lens 30 in the third embodiment.

TABLE 7

| | R | d | | nd | | vd | |
|---|---|---|---|---|---|---|---|
| ST | ∞ | d0 | −12.570 | / | / | / | / |
| Rp1 | 42.185 | dp1 | 9.000 | nd1 | 1.5168 | vd1 | 64.17 |
| Rp2 | 63.916 | dp2 | 3.206 | | | | |
| R1 | 8.092 | d1 | 3.689 | nd2 | 1.5444 | vd2 | 55.82 |
| R2 | −36.336 | d2 | 0.643 | | | | |
| R3 | 7.079 | d3 | 0.712 | nd3 | 1.6150 | vd3 | 25.94 |
| R4 | 3.385 | d4 | 0.138 | | | | |
| R5 | 4.530 | d5 | 1.824 | nd4 | 1.5444 | vd4 | 55.82 |
| R6 | 566.703 | d6 | 0.557 | | | | |
| R7 | −11.922 | d7 | 3.000 | nd5 | 1.6700 | vd5 | 19.39 |
| R8 | −11.736 | d8 | 0.446 | | | | |
| R9 | 11.323 | d9 | 0.992 | nd6 | 1.5444 | vd6 | 55.82 |
| R10 | 3.437 | d10 | 2.000 | | | | |
| R11 | ∞ | d11 | 0.210 | ndg | 1.5168 | vdg | 64.17 |
| R12 | ∞ | d12 | 1.216 | | | | |

In which, d1=“dp1-01”+“dp1-02”, “dp1-01”=4.605, and “dp1-02”=4.395.

Table 8 shows data of related optical parameters for the camera optical lens 30 according to the third embodiment of the present disclosure in a first state and a second state, respectively.

TABLE 8

| | First state | Second state |
|---|---|---|
| fA | 14.500 | 13.630 |
| FOV | 27.34° | 26.14° |
| FNO | 2.60 | 2.86 |
| d6 | 0.557 | 1.346 |
| d10 | 2.000 | 1.211 |

Table 9 shows the conic index and aspherical surface index of the camera optical lens 30.

TABLE 9

| | Conic Index | Aspherical Surface Index | | | | |
|---|---|---|---|---|---|---|
| | k | A4 | A6 | A8 | A10 | A12 |
| R1 | −1.58925E+01 | −8.61300E−06 | 1.76660E−07 | 5.32810E−09 | −1.32120E−09 | 4.21270E−11 |
| R2 | 0.00000E+00 | 0.00000E+00 | 0.00000E+00 | 0.00000E+00 | 0.00000E+00 | 0.00000E+00 |
| R3 | 6.89578E−01 | −9.67640E−04 | −1.24000E−04 | 4.98390E−05 | −2.34240E−05 | 6.22720E−06 |
| R4 | 9.89796E+01 | −5.74570E−03 | 3.52700E−04 | −4.97090E−05 | 6.88720E−06 | −3.94720E−07 |
| R5 | −3.55657E+01 | 7.51790E−05 | −2.60890E−03 | 1.20910E−03 | −4.04670E−04 | 9.87190E−05 |
| R6 | 7.20576E−01 | −1.84010E−02 | 1.55020E−03 | −4.82110E−04 | 2.85250E−04 | −1.54590E−04 |
| R7 | −1.05989E+01 | 8.28990E−03 | −2.94260E−03 | 1.07720E−03 | −3.08220E−04 | 6.87970E−05 |
| R8 | −1.99000E+02 | 1.09170E−03 | −5.05290E−04 | 3.01940E−04 | −2.18150E−04 | 1.46580E−04 |
| R9 | 2.33163E+01 | 4.85910E−03 | −8.02140E−04 | 1.24060E−03 | −9.97300E−04 | 5.15530E−04 |
| R10 | 9.56837E+00 | −1.04470E−02 | 7.58730E−03 | −3.65490E−03 | 1.35220E−03 | −3.41820E−04 |
| R11 | 1.74542E+01 | −5.30460E−02 | 1.51260E−02 | −5.08970E−03 | 1.54740E−03 | −3.56750E−04 |
| R12 | −9.37813E+00 | −1.73070E−02 | 3.48860E−03 | −5.12920E−04 | 5.87410E−06 | 2.17840E−05 |

| | Conic Index | Aspherical Surface Index | | | |
|---|---|---|---|---|---|
| | k | A14 | A16 | A18 | A20 |
| R1 | −1.58925E+01 | 2.03550E−12 | −8.34590E−14 | −1.52790E−15 | 5.79250E−17 |
| R2 | 0.00000E+00 | 0.00000E+00 | 0.00000E+00 | 0.00000E+00 | 0.00000E+00 |
| R3 | 6.89578E−01 | −1.02370E−06 | 1.00730E−07 | −5.38140E−09 | 1.16920E−10 |
| R4 | 9.89796E+01 | 6.04290E−09 | −7.38670E−10 | −1.59900E−10 | 2.12640E−11 |
| R5 | −3.55657E+01 | −1.59570E−05 | 1.63940E−06 | −1.02750E−07 | 3.09570E−09 |
| R6 | 7.20576E−01 | 5.02890E−05 | −9.35350E−06 | 9.97960E−07 | −5.63720E−08 |
| R7 | −1.05989E+01 | −1.28050E−05 | 2.10490E−06 | −1.43680E−07 | −9.06680E−09 |
| R8 | −1.99000E+02 | −6.50080E−05 | 1.65220E−05 | −2.18630E−06 | 1.16600E−07 |
| R9 | 2.33163E+01 | −1.66460E−04 | 3.26190E−05 | −3.53450E−06 | 1.62850E−07 |
| R10 | 9.56837E+00 | 5.45610E−05 | −5.11470E−06 | 2.51390E−07 | −5.06600E−09 |
| R11 | 1.74542E+01 | 5.39410E−05 | −5.03360E−06 | 2.83500E−07 | −8.93520E−09 |
| R12 | −9.37813E+00 | −6.13260E−06 | 8.28550E−07 | −5.68940E−08 | 1.58170E−09 |

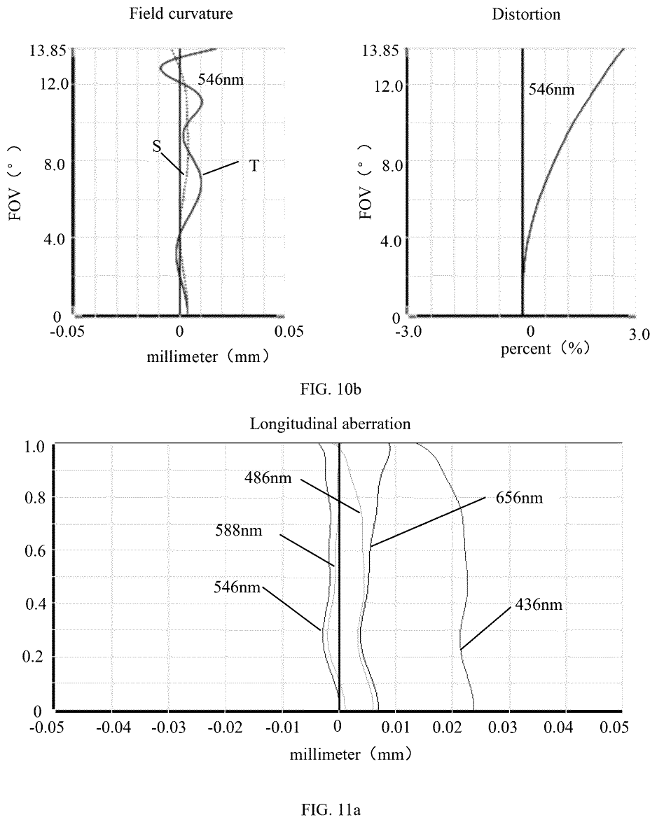

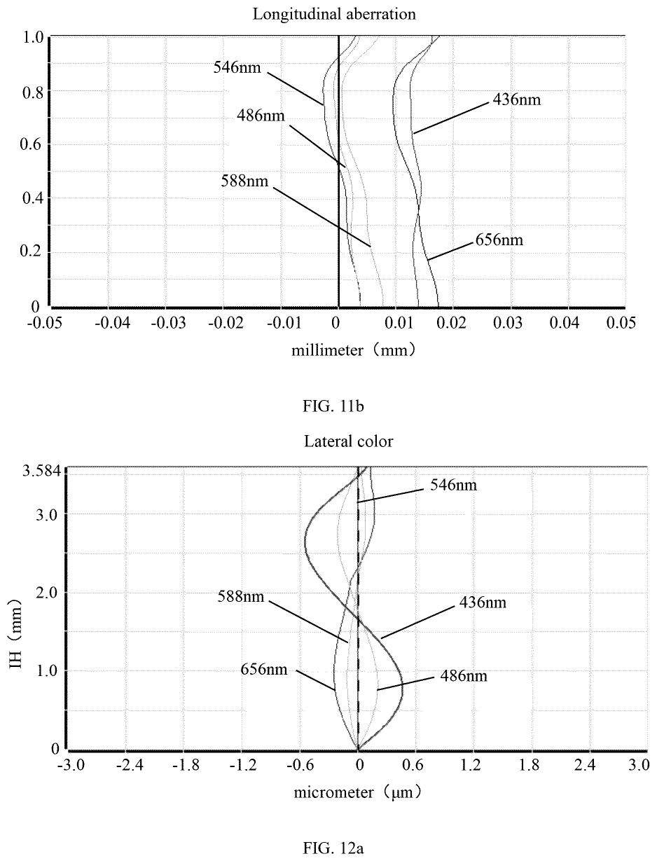

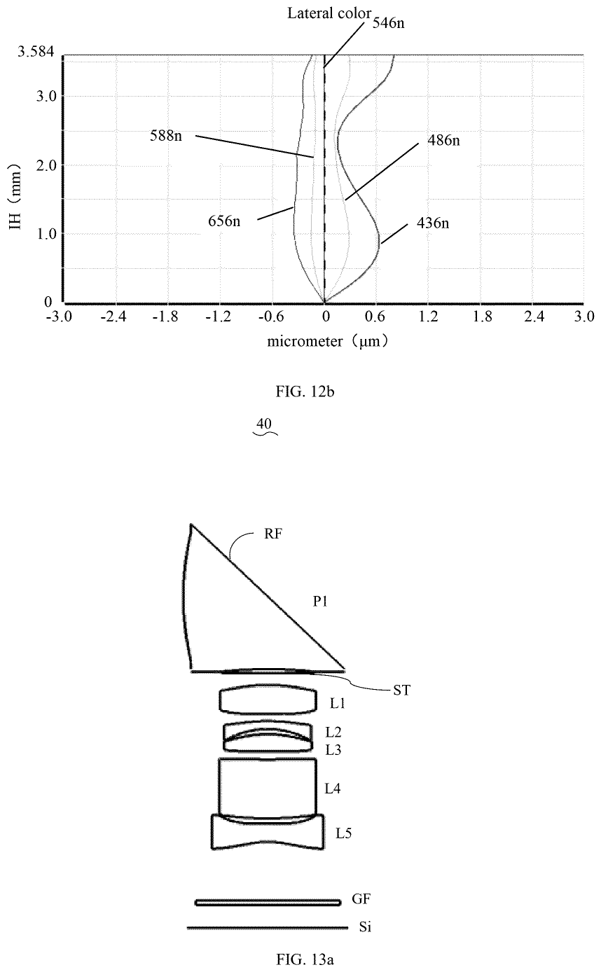

FIG. 10a and FIG. 10b show the field curvature and distortion schematic diagrams after light with a wavelength of 546 nm passes the camera optical lens 30 of the third embodiment. FIG. 11a and FIG. 11b show the longitudinal aberration schematic diagrams after light with a wavelength of 436 nm, 486 nm, 546 nm, 588 nm and 656 nm passes the camera optical lens 30 of the third embodiment. FIG. 12a and FIG. 12b show the lateral color schematic diagrams after light with a wavelength of 436 nm, 486 nm, 546 nm, 588 nm and 656 nm passes the camera optical lens 30 of the third embodiment.

In this embodiment, the entrance pupil diameter (ENPD) of the camera optical lens 30 in the first state is 5.577 mm, the full field image height (IH) is 3.584 mm, and the field of view (FOV) is 27.34°. The camera optical lens 30 enables a large-aperture periscope design, exhibiting superior optical performance with sufficiently corrected on-axis and off-axis chromatic aberrations, and possesses excellent optical characteristics.

### Embodiment 4

The first prism P1 has a positive refractive power, with its object side surface convex in the paraxial region and its image side surface concave in the paraxial region;

The first lens L1 has a positive refractive power, with its object side surface convex in the paraxial region and its image side surface convex in the paraxial region;

The second lens L2 has a negative refractive power, with its object side surface convex in the paraxial region and its image side surface concave in the paraxial region;

The third lens L3 has a positive refractive power, with its object side surface convex in the paraxial region and its image side surface concave in the paraxial region;

The fourth lens L4 has a positive refractive power, with its object side surface concave in the paraxial region and its image side surface convex in the paraxial region;

The fifth lens L5 has a negative refractive power, with its object side surface convex in the paraxial region and its image side surface concave in the paraxial region.

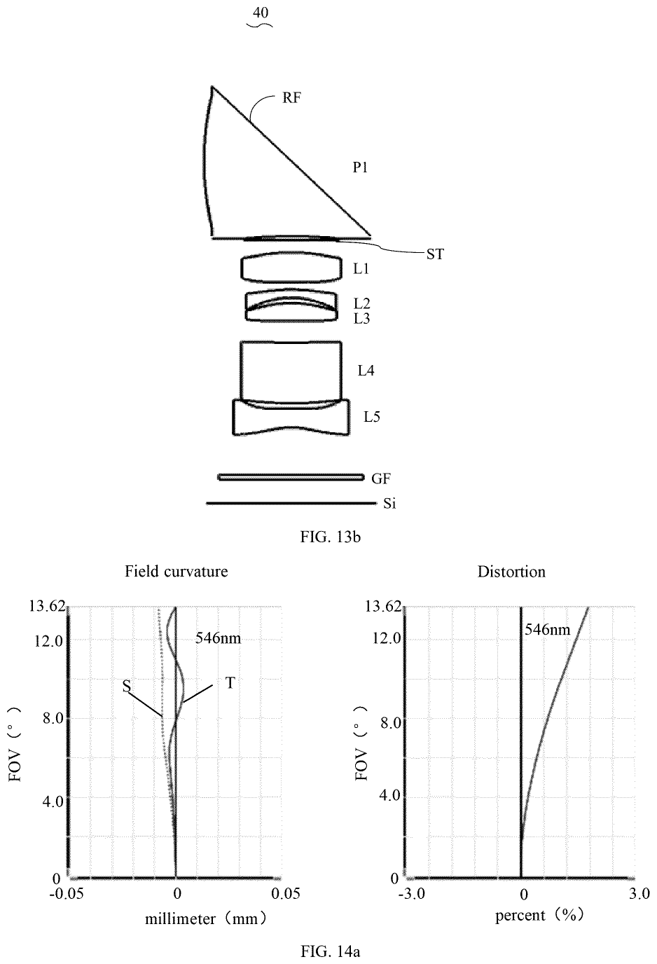

FIGS. 13a and 13b are schematic structural diagrams of the camera optical lens 40 in the fourth embodiment. The symbol meanings in the fourth embodiment are the same as those in the first embodiment.

Table 10 shows the design data of the camera optical lens 40 in the fourth embodiment.

TABLE 10

| | R | d | | nd | | vd | |
|---|---|---|---|---|---|---|---|
| ST | ∞ | d0 | −7.986 | / | / | / | / |
| Rp1 | 13.871 | dp1 | 7.778 | nd1 | 1.5168 | vd1 | 64.17 |
| Rp2 | 19.265 | dp2 | 0.800 | | | | |
| R1 | 7.011 | d1 | 1.487 | nd2 | 1.5444 | vd2 | 55.82 |
| R2 | −85.405 | d2 | 0.351 | | | | |
| R3 | 6.847 | d3 | 0.405 | nd3 | 1.6150 | vd3 | 25.94 |
| R4 | 3.395 | d4 | 0.269 | | | | |
| R5 | 5.137 | d5 | 0.884 | nd4 | 1.5444 | vd4 | 55.82 |
| R6 | −53.338 | d6 | 0.400 | | | | |
| R7 | −32.113 | d7 | 2.998 | nd5 | 1.6700 | vd5 | 19.39 |
| R8 | −19.835 | d8 | 0.254 | | | | |
| R9 | 11.496 | d9 | 0.942 | nd6 | 1.5444 | vd6 | 55.82 |
| R10 | 3.193 | d10 | 3.000 | | | | |
| R11 | ∞ | d11 | 0.210 | ndg | 1.5168 | vdg | 64.17 |
| R12 | ∞ | d12 | 1.194 | | | | |

In which, d1=“dp1-01”+dp1-02, “dp1-01”=4.070, and “dp1-02”=3.708.

Table 11 shows data of related optical parameters for the camera optical lens 40 according to the fourth embodiment of the present disclosure in a first state and a second state, respectively.

TABLE 11

| | First state | Second state |
|---|---|---|
| fA | 14.535 | 13.580 |
| FOV | 27.24° | 26.04° |
| FNO | 2.60 | 2.78 |
| d6 | 0.400 | 1.169 |
| d10 | 3.000 | 2.231 |

Table 12 shows the conic index and aspherical surface index of the camera optical lens 40.

TABLE 12

| | Conic Index | Aspherical Surface Index | | | | |
|---|---|---|---|---|---|---|
| | k | A4 | A6 | A8 | A10 | A12 |
| R1 | −6.87283E+00 | 1.17540E−04 | −6.80920E−06 | 3.17760E−08 | 2.16520E−09 | −2.11270E−10 |
| R2 | 0.00000E+00 | 0.00000E+00 | 0.00000E+00 | 0.00000E+00 | 0.00000E+00 | 0.00000E+00 |
| R3 | −5.50157E−01 | −1.27090E−03 | −2.62900E−04 | 3.58010E−05 | −2.44550E−05 | 6.20390E−06 |
| R4 | 1.98992E+02 | −6.20020E−03 | 1.71840E−04 | −5.81340E−05 | 5.62350E−06 | −5.19420E−07 |
| R5 | −3.44837E+01 | 2.21640E−03 | −2.09860E−03 | 1.17970E−03 | −4.18040E−04 | 9.81420E−05 |
| R6 | 9.71451E−01 | −1.44740E−02 | 1.66080E−03 | −4.76870E−04 | 2.81530E−04 | −1.57360E−04 |
| R7 | −1.14989E+01 | 8.34160E−03 | −3.03130E−03 | 1.06470E−03 | −3.04040E−04 | 6.88510E−05 |
| R8 | −1.98987E+02 | 5.37690E−04 | −9.18850E−04 | 3.40890E−04 | −2.30330E−04 | 1.46180E−04 |
| R9 | 4.78035E+01 | 3.25240E−03 | −1.11640E−03 | 1.29520E−03 | −1.01200E−03 | 5.13860E−04 |
| R10 | 1.38703E+01 | −9.84410E−03 | 7.49120E−03 | −3.66850E−03 | 1.34650E−03 | −3.41880E−04 |
| R11 | 8.38621E+00 | −4.89130E−02 | 1.46350E−02 | −5.09820E−03 | 1.55550E−03 | −3.57260E−04 |
| R12 | −6.57746E+00 | −1.74800E−02 | 3.79070E−03 | −5.76360E−04 | 6.15360E−06 | 2.29780E−05 |

| | Conic Index | Aspherical Surface Index | | | |
|---|---|---|---|---|---|
| | k | A14 | A16 | A18 | A20 |
| R1 | −6.87283E+00 | −1.85250E−11 | 1.20310E−12 | 4.98380E−14 | −3.44840E−15 |
| R2 | 0.00000E+00 | 0.00000E+00 | 0.00000E+00 | 0.00000E+00 | 0.00000E+00 |
| R3 | −5.50157E−01 | −1.03440E−06 | 9.84820E−08 | −5.31350E−09 | 1.40930E−10 |
| R4 | 1.98992E+02 | 2.00010E−08 | 3.04990E−09 | −2.84420E−10 | 4.57050E−13 |
| R5 | −3.44837E+01 | −1.57400E−05 | 1.67340E−06 | −1.03190E−07 | 2.92770E−09 |
| R6 | 9.71451E−01 | 4.95350E−05 | −9.44850E−06 | 1.00180E−06 | −4.79610E−08 |
| R7 | −1.14989E+01 | −1.33940E−05 | 1.90680E−06 | −1.57750E−07 | 4.50710E−10 |
| R8 | −1.98987E+02 | −6.46430E−05 | 1.65070E−05 | −2.21590E−06 | 1.19140E−07 |
| R9 | 4.78035E+01 | −1.65930E−04 | 3.27050E−05 | −3.57190E−06 | 1.65200E−07 |
| R10 | 1.38703E+01 | 5.47140E−05 | −5.10290E−06 | 2.50690E−07 | −5.68600E−09 |
| R11 | 8.38621E+00 | 5.37920E−05 | −5.00550E−06 | 2.93970E−07 | −1.07240E−08 |
| R12 | −6.57746E+00 | −6.17430E−06 | 8.20350E−07 | −5.72220E−08 | 1.66440E−09 |

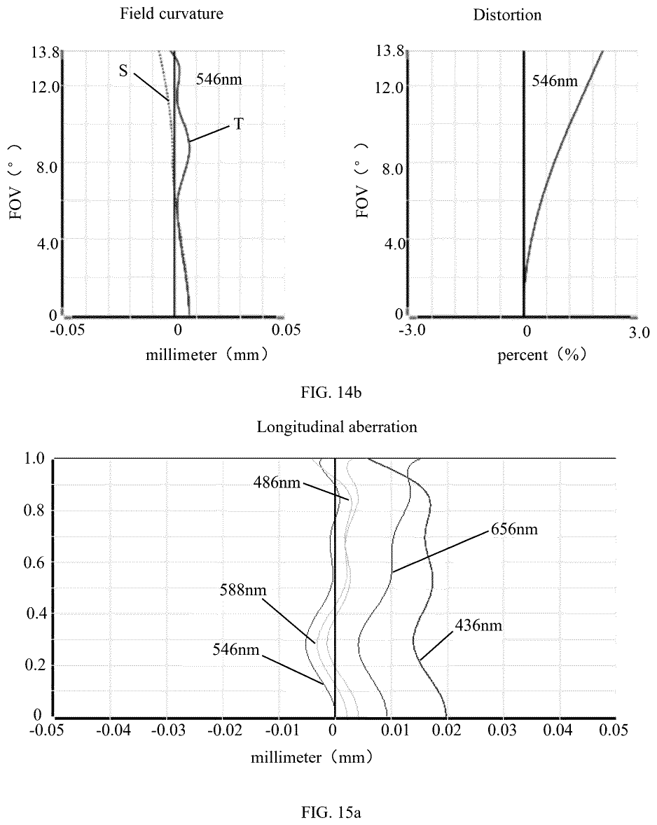

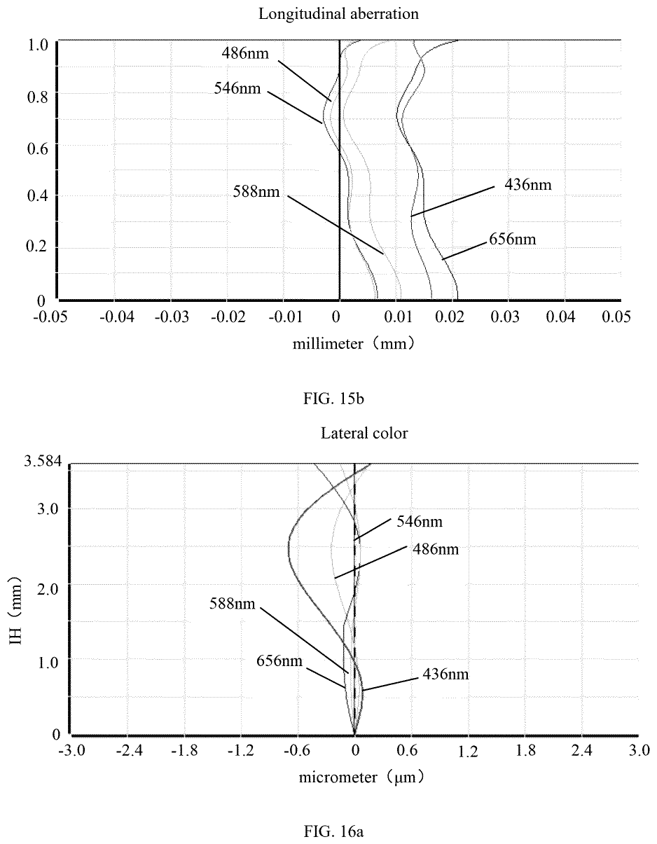

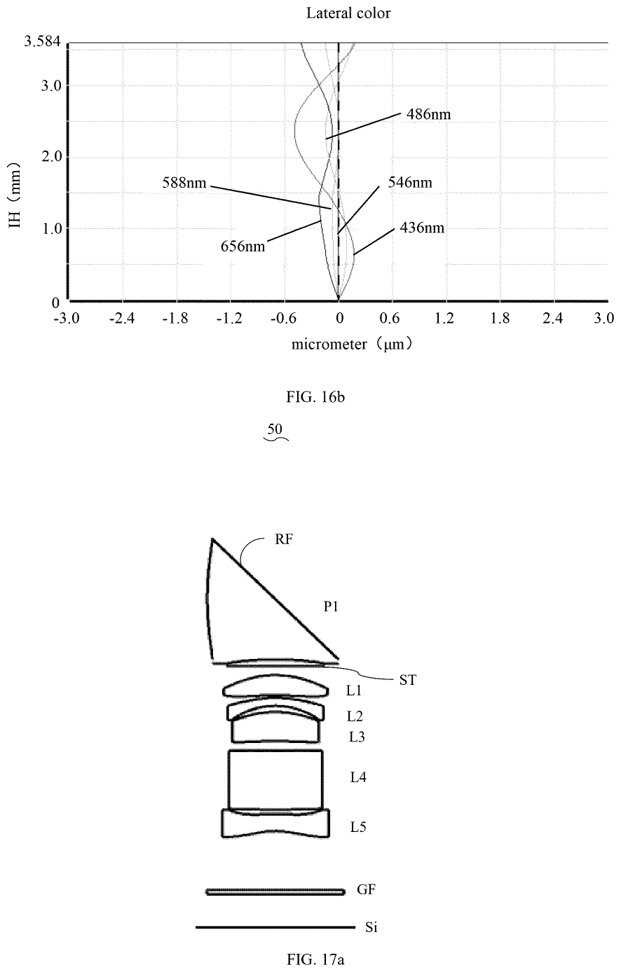

FIG. 14a and FIG. 14b show the field curvature and distortion schematic diagrams after light with a wavelength of 546 nm passes the camera optical lens 40 of the fourth embodiment. FIG. 15a and FIG. 15b show the longitudinal aberration schematic diagrams after light with a wavelength of 436 nm, 486 nm, 546 nm, 588 nm and 656 nm passes the camera optical lens 40 of the fourth embodiment. FIG. 16a and FIG. 16b show the lateral color schematic diagrams after light with a wavelength of 436 nm, 486 nm, 546 nm, 588 nm and 656 nm passes the camera optical lens 40 of the fourth embodiment.

In this embodiment, the entrance pupil diameter (ENPD) of the camera optical lens 40 in the first state is 5.59 mm, the full field image height (IH) is 3.584 mm, and the field of view (FOV) is 27.24°. The camera optical lens 40 enables a large-aperture periscope design, exhibiting superior optical performance with sufficiently corrected on-axis and off-axis chromatic aberrations, and possesses excellent optical characteristics.

### Embodiment 5

The first prism P1 has a positive refractive power, with its object side surface convex in the paraxial region and its image side surface concave in the paraxial region;

The first lens L1 has a positive refractive power, with its object side surface convex in the paraxial region and its image side surface concave in the paraxial region;

The second lens L2 has a negative refractive power, with its object side surface convex in the paraxial region and its image side surface concave in the paraxial region;

The third lens L3 has a positive refractive power, with its object side surface convex in the paraxial region and its image side surface concave in the paraxial region;

The fourth lens L4 has a negative refractive power, with its object side surface concave in the paraxial region and its image side surface convex in the paraxial region;

The fifth lens L5 has a negative refractive power, with its object side surface convex in the paraxial region and its image side surface concave in the paraxial region.

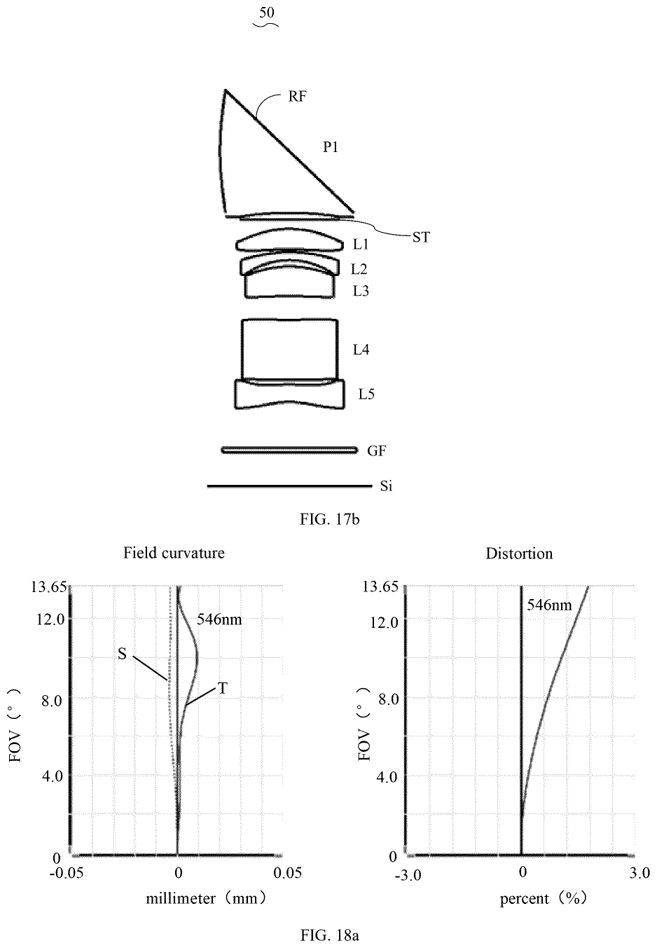

FIGS. 17a and 17b are schematic structural diagrams of the camera optical lens 50 in the fifth embodiment. The symbol meanings in the fifth embodiment are the same as those in the first embodiment.

Table 13 shows the design data of the camera optical lens 50 in the fifth embodiment.

TABLE 13

| | R | d | | nd | | vd | |
|---|---|---|---|---|---|---|---|
| ST | ∞ | d0 | −6.750 | / | / | / | / |
| Rp1 | 15.859 | dp1 | 6.404 | nd1 | 1.5168 | vd1 | 64.17 |
| Rp2 | 14.417 | dp2 | 0.800 | | | | |
| R1 | 4.554 | d1 | 1.017 | nd2 | 1.5444 | vd2 | 55.82 |
| R2 | 9.856 | d2 | 0.140 | | | | |
| R3 | 4.802 | d3 | 0.400 | nd3 | 1.6150 | vd3 | 25.94 |
| R4 | 3.102 | d4 | 0.313 | | | | |
| R5 | 4.233 | d5 | 1.491 | nd4 | 1.5444 | vd4 | 55.82 |
| R6 | 34.082 | d6 | 0.473 | | | | |
| R7 | −51.174 | d7 | 3.000 | nd5 | 1.6700 | vd5 | 19.39 |
| R8 | −107.850 | d8 | 0.227 | | | | |
| R9 | 7.687 | d9 | 0.868 | nd6 | 1.5444 | vd6 | 55.82 |
| R10 | 3.411 | d10 | 3.000 | | | | |
| R11 | ∞ | d11 | 0.210 | ndg | 1.5168 | vdg | 64.17 |
| R12 | ∞ | d12 | 1.701 | | | | |

In which, d1=“dp1-01”+“dp1-02”, “dp1-01”=3.322, and “dp1-02”=3.082.

Table 14 shows data of related optical parameters for the camera optical lens 50 according to the fifth embodiment of the present disclosure in a first state and a second state, respectively.

TABLE 14

| | First state | Second state |
|---|---|---|
| fA | 14.500 | 13.690 |
| FOV | 27.30° | 26.11° |
| FNO | 2.60 | 2.87 |
| d6 | 0.473 | 1.263 |
| d10 | 3.000 | 2.210 |

Table 15 shows the conic index and aspherical surface index of the camera optical lens 50.

TABLE 15

| | Conic Index | Aspherical Surface Index | | | | |
|---|---|---|---|---|---|---|
| | k | A4 | A6 | A8 | A10 | A12 |
| R1 | −1.24136E+01 | 5.06710E−05 | −1.30520E−05 | −1.30580E−08 | 1.86720E−08 | −1.68020E−09 |
| R2 | 0.00000E+00 | 0.00000E+00 | 0.00000E+00 | 0.00000E+00 | 0.00000E+00 | 0.00000E+00 |
| R3 | 4.65581E−01 | −1.24270E−03 | −1.71870E−04 | 4.46670E−05 | −2.49220E−05 | 6.08730E−06 |
| R4 | −1.20296E+02 | −4.09120E−03 | 3.38070E−04 | −5.37360E−05 | 4.59860E−06 | −7.46400E−07 |
| R5 | −2.45558E+01 | 4.37980E−03 | −1.90160E−03 | 1.19470E−03 | −4.17790E−04 | 9.79590E−05 |
| R6 | 6.44010E−01 | −1.53330E−02 | 1.74190E−03 | −4.47870E−04 | 2.88190E−04 | −1.56430E−04 |
| R7 | −6.44843E+00 | 6.47000E−03 | −3.18220E−03 | 1.13370E−03 | −3.04310E−04 | 6.99660E−05 |
| R8 | 1.44081E+02 | 1.95710E−03 | −9.13030E−04 | 3.36030E−04 | −2.23220E−04 | 1.48200E−04 |
| R9 | 1.63748E+02 | 3.01710E−03 | −1.06430E−03 | 1.27230E−03 | −1.01050E−03 | 5.14320E−04 |
| R10 | 1.91302E+02 | −1.07360E−02 | 8.02580E−03 | −3.78340E−03 | 1.34900E−03 | −3.40270E−04 |
| R11 | 6.45390E+00 | −4.69600E−02 | 1.39510E−02 | −5.06430E−03 | 1.55320E−03 | −3.57290E−04 |
| R12 | −6.32367E+00 | −1.70590E−02 | 3.39440E−03 | −5.17280E−04 | 3.49070E−06 | 2.24290E−05 |

| | Conic Index | Aspherical Surface Index | | | |
|---|---|---|---|---|---|
| | k | A14 | A16 | A18 | A20 |
| R1 | −1.24136E+01 | 7.53610E−11 | −2.21560E−12 | −1.45000E−12 | 1.31700E−13 |
| R2 | 0.00000E+00 | 0.00000E+00 | 0.00000E+00 | 0.00000E+00 | 0.00000E+00 |
| R3 | 4.65581E−01 | −1.02490E−06 | 1.00770E−07 | −5.67310E−09 | 3.86980E−11 |
| R4 | −1.20296E+02 | −1.56030E−08 | 7.12780E−10 | 7.08580E−10 | −7.39060E−11 |
| R5 | −2.45558E+01 | −1.58060E−05 | 1.64890E−06 | −1.07870E−07 | 3.97560E−09 |
| R6 | 6.44010E−01 | 4.95560E−05 | −9.45230E−06 | 9.98700E−07 | −5.03910E−08 |
| R7 | −6.44843E+00 | −1.30760E−05 | 1.95310E−06 | −1.59640E−07 | 6.66220E−10 |
| R8 | 1.44081E+02 | −6.48530E−05 | 1.64560E−05 | −2.20390E−06 | 1.20060E−07 |
| R9 | 1.63748E+02 | −1.65840E−04 | 3.26860E−05 | −3.58390E−06 | 1.67210E−07 |
| R10 | 1.91302E+02 | 5.49390E−05 | −5.11950E−06 | 2.38170E−07 | −4.42840E−09 |
| R11 | 6.45390E+00 | 5.39220E−05 | −4.99560E−06 | 2.95190E−07 | −1.17080E−08 |
| R12 | −6.32367E+00 | −6.12540E−06 | 8.31180E−07 | −5.88400E−08 | 1.70620E−09 |

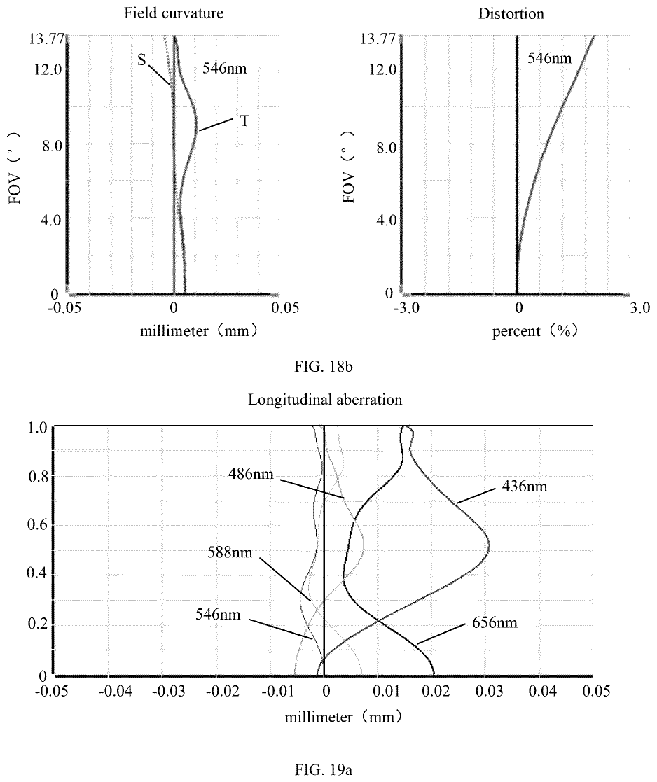

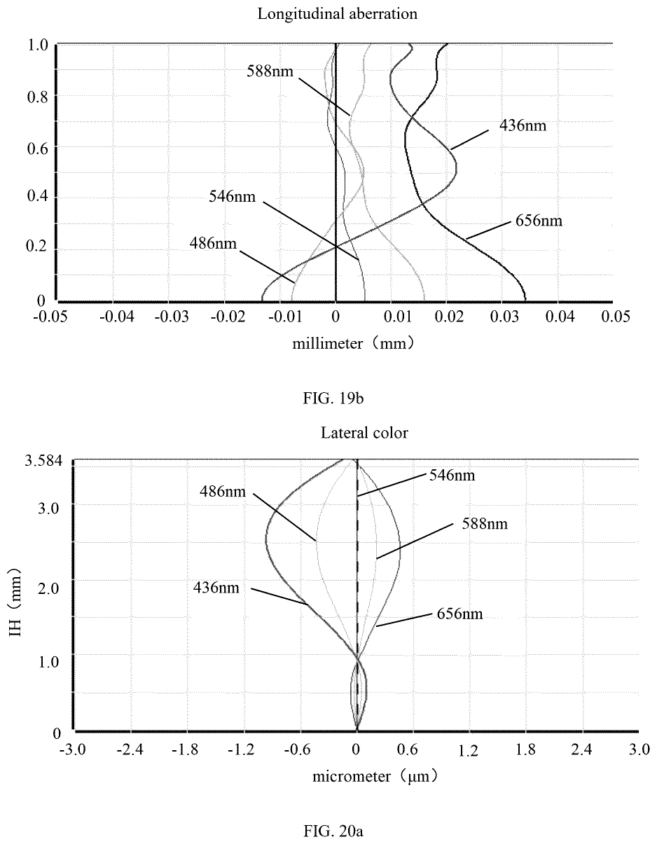

FIG. 18a and FIG. 18b show the field curvature and distortion schematic diagrams after light with a wavelength of 546 nm passes the camera optical lens 50 of the fifth embodiment. FIG. 19a and FIG. 19b show the longitudinal aberration schematic diagrams after light with a wavelength of 436 nm, 486 nm, 546 nm, 588 nm and 656 nm passes the camera optical lens 50 of the fifth embodiment. FIG. 20a and FIG. 20b show the lateral color schematic diagrams after light with a wavelength of 436 nm, 486 nm, 546 nm, 588 nm and 656 nm passes the camera optical lens 50 of the fifth embodiment.

In this embodiment, the entrance pupil diameter (ENPD) of the camera optical lens 50 in the first state is 5.577 mm, the full field image height (IH) is 3.584 mm, and the field of view (FOV) is 27.300. The camera optical lens 50 enables a large-aperture periscope design, exhibiting superior optical performance with sufficiently corrected on-axis and off-axis chromatic aberrations, and possesses excellent optical characteristics.

### Embodiment 6

The first prism P1 has a positive refractive power, with its object side surface planar in the paraxial region and its image side surface planar in the paraxial region;

The first lens L1 has a negative refractive power, with its object side surface convex in the paraxial region and its image side surface concave in the paraxial region;

The second lens L2 has a positive refractive power, with its object side surface convex in the paraxial region and its image side surface convex in the paraxial region;

The third lens L3 has a negative refractive power, with its object side surface convex in the paraxial region and its image side surface concave in the paraxial region;

The fourth lens L4 has a negative refractive power, with its object side surface concave in the paraxial region and its image side surface convex in the paraxial region;

The fifth lens L5 has a negative refractive power, with its object side surface convex in the paraxial region and its image side surface concave in the paraxial region.

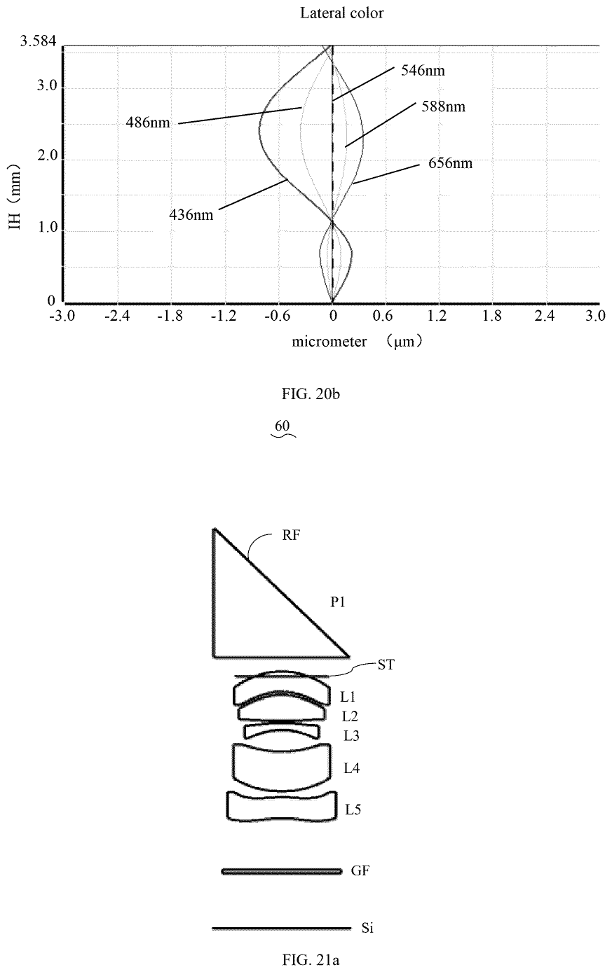

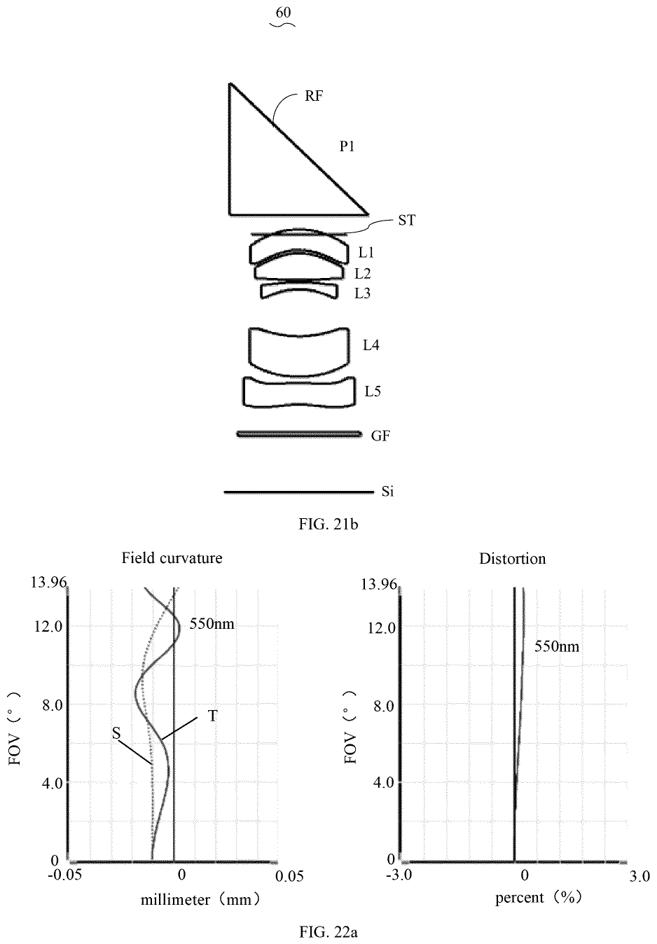

FIGS. 21a and 21b are schematic structural diagrams of the camera optical lens 60 in the sixth embodiment. The symbol meanings in the sixth embodiment are the same as those in the first embodiment.

Table 16 shows the design data of the camera optical lens 60 in the sixth embodiment.

TABLE 16

| | R | d | | nd | | vd | |
|---|---|---|---|---|---|---|---|
| ST | ∞ | d0 | −8.696 | / | / | / | / |
| Rp1 | 250.000 | dp1 | 7.601 | nd1 | 1.5168 | vd1 | 64.17 |
| Rp2 | −357.134 | dp2 | 0.800 | | | | |
| R1 | 3.937 | d1 | 1.167 | nd2 | 1.5444 | vd2 | 55.82 |
| R2 | 2.596 | d2 | 0.194 | | | | |
| R3 | 2.692 | d3 | 1.533 | nd3 | 1.5444 | vd3 | 55.82 |
| R4 | −51.621 | d4 | 0.116 | | | | |
| R5 | 6.425 | d5 | 0.416 | nd4 | 1.6400 | vd4 | 23.54 |
| R6 | 3.339 | d6 | 1.267 | | | | |
| R7 | −5.192 | d7 | 2.308 | nd5 | 1.6610 | vd5 | 20.53 |
| R8 | −6.793 | d8 | 0.350 | | | | |
| R9 | 6.092 | d9 | 1.233 | nd6 | 1.6153 | vd6 | 25.94 |
| R10 | 5.330 | d10 | 3.000 | | | | |
| R11 | ∞ | d11 | 0.210 | ndg | 1.5168 | vdg | 64.17 |
| R12 | ∞ | d12 | 3.240 | | | | |

In which, d1=“dp1-31”+“dp1-02”, “dp1-01”=3.800, and “dp1-02”=3.801.

Table 17 shows data of related optical parameters for the camera optical lens 60 according to the sixth embodiment of the present disclosure in a first state and a second state, respectively.

TABLE 17

| | First state | Second state |
|---|---|---|
| fA | 14.372 | 13.250 |
| FOV | 27.92° | 26.78° |
| FNO | 2.69 | 2.77 |
| d6 | 1.267 | 2.125 |
| d10 | 3.000 | 2.142 |

Table 18 shows the conic index and aspherical surface index of the camera optical lens 60.

TABLE 18

| | Conic Index | Aspherical Surface Index | | | | |
|---|---|---|---|---|---|---|
| | k | A4 | A6 | A8 | A10 | A12 |
| R1 | 3.45900E+02 | −9.08650E−05 | −4.10740E−06 | 7.79240E−07 | −5.59900E−08 | −1.94580E−10 |
| R2 | 0.00000E+00 | 0.00000E+00 | 0.00000E+00 | 0.00000E+00 | 0.00000E+00 | 0.00000E+00 |
| R3 | −1.01607E−01 | −2.26480E−03 | 6.68280E−04 | −1.43080E−04 | 2.43770E−05 | −6.59410E−06 |
| R4 | −4.82599E+00 | 3.99800E−03 | −2.24980E−03 | 3.73830E−03 | −1.92280E−03 | 4.73180E−04 |
| R5 | −4.47145E+00 | 8.01000E−04 | −1.76080E−03 | 3.52790E−03 | −1.56520E−03 | 2.68900E−04 |
| R6 | 1.98997E+02 | −3.31400E−02 | 3.31880E−02 | −1.77960E−02 | 5.83890E−03 | −1.25500E−03 |
| R7 | −4.09983E−02 | −4.01320E−02 | 3.63710E−02 | −1.94790E−02 | 5.16330E−03 | −3.75700E−04 |
| R8 | 1.85820E−02 | −1.44210E−02 | 9.46200E−03 | −4.26530E−03 | −6.43010E−04 | 1.52230E−03 |
| R9 | 1.08889E+00 | 5.03910E−03 | 8.55530E−05 | −8.36640E−04 | 9.61820E−04 | −5.92710E−04 |
| R10 | 2.60313E+00 | −1.74080E−02 | 8.67470E−03 | −3.04530E−03 | 7.68620E−04 | −1.30520E−04 |
| R11 | −8.58894E+00 | −3.23670E−02 | 9.03590E−03 | −2.79190E−03 | 6.60380E−04 | −1.11580E−04 |
| R12 | −1.39790E+01 | −8.80880E−03 | −1.51500E−04 | 3.81070E−04 | −1.36420E−04 | 2.76390E−05 |

| | Conic Index | Aspherical Surface Index | | | |
|---|---|---|---|---|---|
| | k | A14 | A16 | A18 | A20 |
| R1 | 3.45900E+02 | 1.89910E−10 | 2.37610E−12 | −9.94530E−13 | 3.09670E−14 |
| R2 | 0.00000E+00 | 0.00000E+00 | 0.00000E+00 | 0.00000E+00 | 0.00000E+00 |
| R3 | −1.01607E−01 | 1.54790E−06 | −2.22420E−07 | 1.70140E−08 | −5.69540E−10 |
| R4 | −4.82599E+00 | −6.21330E−05 | 3.94660E−06 | −6.41090E−08 | −2.70570E−09 |
| R5 | −4.47145E+00 | −4.02970E−06 | −5.09250E−06 | 6.87340E−07 | −2.89580E−08 |
| R6 | 1.98997E+02 | 1.83000E−04 | −1.79830E−05 | 1.10590E−06 | −3.17250E−08 |
| R7 | −4.09983E−02 | −1.56320E−04 | 4.73760E−05 | −5.29370E−06 | 2.21740E−07 |
| R8 | 1.85820E−02 | −7.10310E−04 | 1.64370E−04 | −1.94860E−05 | 9.43240E−07 |
| R9 | 1.08889E+00 | 2.14570E−04 | −4.56900E−05 | 5.30050E−06 | −2.58360E−07 |
| R10 | 2.60313E+00 | 1.33430E−05 | −6.36480E−07 | −2.77440E−09 | 1.03220E−09 |
| R11 | −8.58894E+00 | 1.24200E−05 | −8.55470E−07 | 3.44140E−08 | −6.84030E−10 |
| R12 | −1.39790E+01 | −3.37970E−06 | 2.36600E−07 | −8.02690E−09 | 7.71300E−11 |

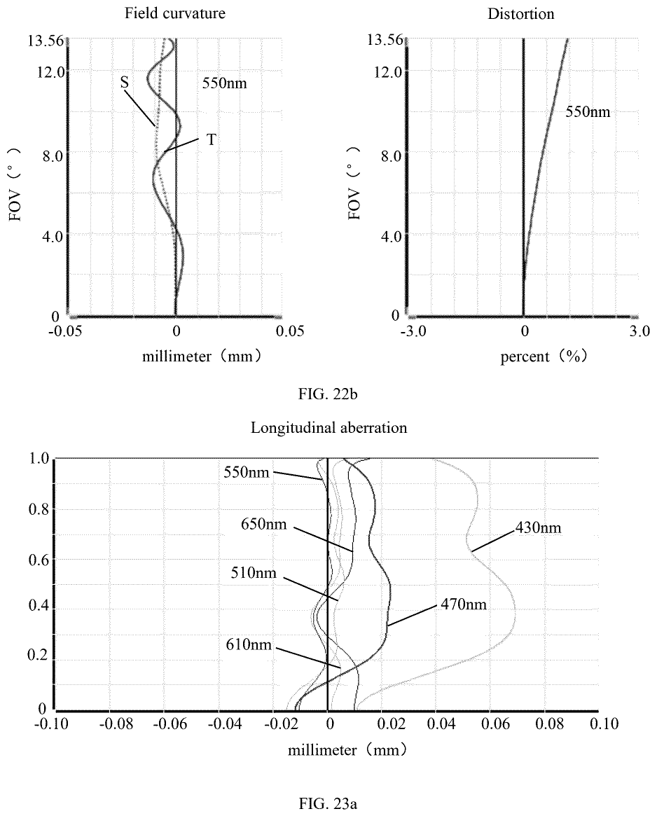

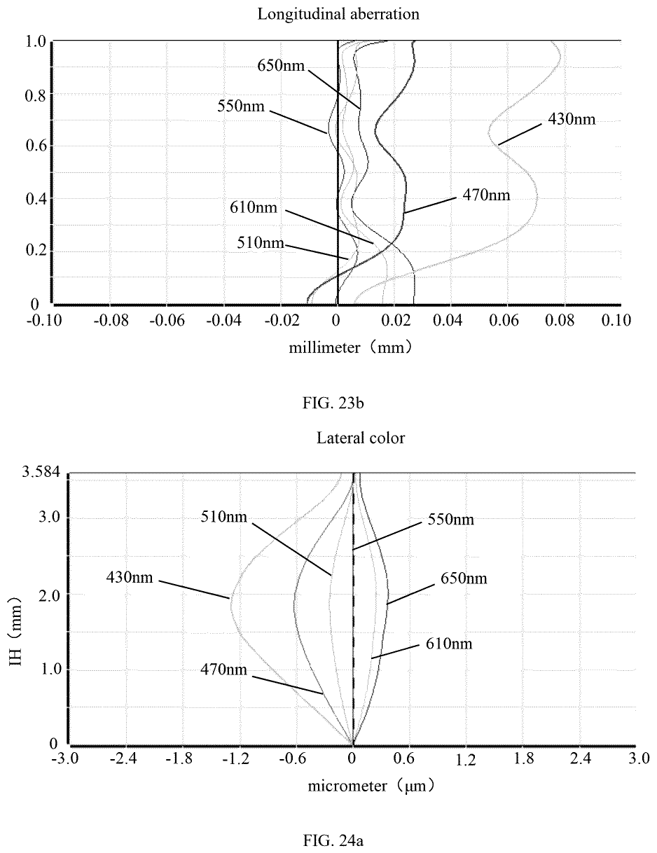

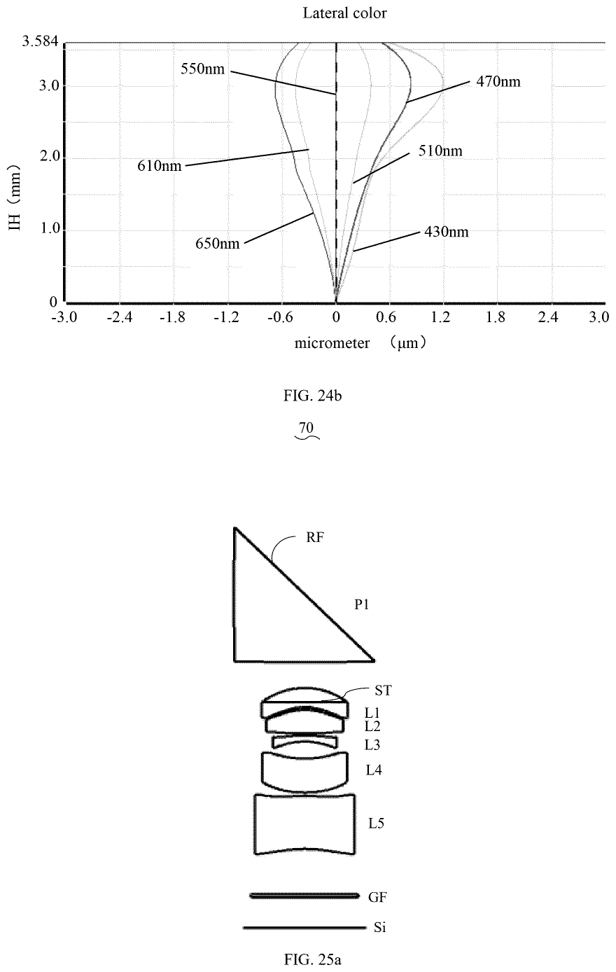

FIG. 22a and FIG. 22b show the field curvature and distortion schematic diagrams after light with a wavelength of 550 nm passes the camera optical lens 60 of the sixth embodiment. FIG. 23a and FIG. 23b show the longitudinal aberration schematic diagrams after light with a wavelength of 430 nm, 470 nm, 510 nm, 550 nm, 610 nm and 650 nm passes the camera optical lens 60 of the sixth embodiment. FIG. 24a and FIG. 24b show the lateral color schematic diagrams after light with a wavelength of 430 nm, 470 nm, 510 nm, 550 nm, 610 nm and 650 nm passes the camera optical lens 60 of the sixth embodiment.

In this embodiment, the entrance pupil diameter (ENPD) of the camera optical lens 60 in the first state is 5.349 mm, the full field image height (IH) is 3.584 mm, and the field of view (FOV) is 27.92°. The camera optical lens 60 enables a large-aperture periscope design, exhibiting superior optical performance with sufficiently corrected on-axis and off-axis chromatic aberrations, and possesses excellent optical characteristics.

### Embodiment 7

The first prism P1 has a positive refractive power, with its object side surface convex in the paraxial region and its image side surface convex in the paraxial region;

The first lens L1 has a negative refractive power, with its object side surface convex in the paraxial region and its image side surface concave in the paraxial region;

The second lens L2 has a positive refractive power, with its object side surface convex in the paraxial region and its image side surface convex in the paraxial region;

The third lens L3 has a negative refractive power, with its object side surface convex in the paraxial region and its image side surface concave in the paraxial region;

The fourth lens L4 has a negative refractive power, with its object side surface concave in the paraxial region and its image side surface convex in the paraxial region;

The fifth lens L5 has a positive refractive power, with its object side surface convex in the paraxial region and its image side surface concave in the paraxial region.

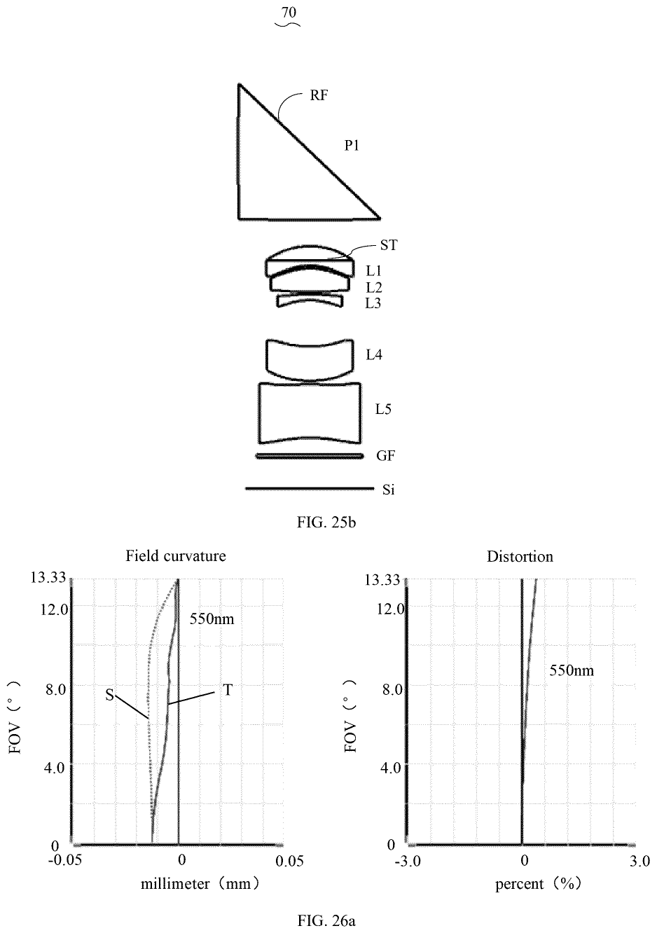

FIGS. 25a and 25b are schematic structural diagrams of the camera optical lens 70 in the seventh embodiment. The symbol meanings in the seventh embodiment are the same as those in the first embodiment.

Table 19 shows the design data of the camera optical lens 70 in the seventh embodiment.

TABLE 19

| | R | d | | nd | | vd | |
|---|---|---|---|---|---|---|---|
| ST | ∞ | d0 | −11.627 | / | / | / | / |
| Rp1 | 130.000 | dp1 | 9.000 | nd1 | 1.5168 | vd1 | 64.17 |
| Rp2 | −111.111 | dp2 | 1.706 | | | | |
| R1 | 4.376 | d1 | 1.265 | nd2 | 1.5444 | vd2 | 55.82 |
| R2 | 3.017 | d2 | 0.178 | | | | |
| R3 | 3.163 | d3 | 1.565 | nd3 | 1.5444 | vd3 | 55.82 |
| R4 | −61.824 | d4 | 0.138 | | | | |
| R5 | 7.154 | d5 | 0.400 | nd4 | 1.6400 | vd4 | 23.54 |
| R6 | 3.824 | d6 | 1.131 | | | | |
| R7 | −6.027 | d7 | 2.242 | nd5 | 1.6610 | vd5 | 20.53 |
| R8 | −9.853 | d8 | 0.225 | | | | |
| R9 | 8.265 | d9 | 3.513 | nd6 | 1.6153 | vd6 | 25.94 |
| R10 | 7.466 | d10 | 3.000 | | | | |
| R11 | ∞ | d11 | 0.210 | ndg | 1.5168 | vdg | 64.17 |
| R12 | ∞ | d12 | 2.036 | | | | |

In which, d1=“dp1-01”+“dp1-02”, “dp1-01”=4.496, and “dp1-02”=4.504.

Table 20 shows data of related optical parameters for the camera optical lens 70 according to the seventh embodiment of the present disclosure in a first state and a second state, respectively.

TABLE 20

| | First state | Second state |
|---|---|---|
| fA | 15.053 | 14.120 |
| FOV | 26.66° | 15.98° |
| FNO | 2.69 | 2.79 |
| d6 | 1.131 | 2.365 |
| d10 | 3.000 | 1.766 |

Table 21 shows the conic index and aspherical surface index of the camera optical lens 70.

TABLE 21

| | Conic Index | Aspherical Surface Index | | | | |
|---|---|---|---|---|---|---|
| | k | A4 | A6 | A8 | A10 | A12 |
| R1 | −1.57742E+03 | −2.32550E−05 | −3.04200E−06 | 7.96710E−08 | 6.31480E−09 | −4.65850E−10 |
| R2 | 0.00000E+00 | 0.00000E+00 | 0.00000E+00 | 0.00000E+00 | 0.00000E+00 | 0.00000E+00 |
| R3 | 5.49372E−02 | −1.05440E−03 | 5.61700E−04 | −1.30710E−04 | 2.36930E−05 | −6.43880E−06 |
| R4 | −7.12686E+00 | 5.47770E−03 | −2.59420E−03 | 3.77980E−03 | −1.92400E−03 | 4.72470E−04 |
| R5 | −7.18636E+00 | 3.14070E−04 | −1.82420E−03 | 3.45570E−03 | −1.56150E−03 | 2.70660E−04 |
| R6 | 1.99000E+02 | −3.38770E−02 | 3.28170E−02 | −1.77730E−02 | 5.84760E−03 | −1.25460E−03 |
| R7 | 1.52890E+00 | −3.81010E−02 | 3.53370E−02 | −1.94740E−02 | 5.17940E−03 | −3.72800E−04 |
| R8 | −1.12153E−02 | −1.24680E−02 | 8.94740E−03 | −4.30190E−03 | −6.88050E−04 | 1.53480E−03 |
| R9 | 1.61771E+00 | 2.25430E−03 | 5.79780E−04 | −1.00330E−03 | 1.00060E−03 | −5.98280E−04 |
| R10 | 1.10416E+01 | −2.24100E−02 | 9.75320E−03 | −3.17600E−03 | 7.78810E−04 | −1.30910E−04 |
| R11 | 4.70635E+00 | −2.98160E−02 | 9.47330E−03 | −2.90020E−03 | 6.65880E−04 | −1.09420E−04 |
| R12 | −2.54116E+01 | 3.07440E−03 | −1.65890E−03 | 5.61340E−04 | −1.46080E−04 | 2.67420E−05 |

| | Conic Index | Aspherical Surface Index | | | |
|---|---|---|---|---|---|
| | k | A14 | A16 | A18 | A20 |
| R1 | −1.57742E+03 | −9.46620E−12 | 1.99130E−12 | −7.53120E−14 | 9.70660E−16 |
| R2 | 0.00000E+00 | 0.00000E+00 | 0.00000E+00 | 0.00000E+00 | 0.00000E+00 |
| R3 | 5.49372E−02 | 1.55120E−06 | −2.25290E−07 | 1.68800E−08 | −5.27090E−10 |
| R4 | −7.12686E+00 | −6.20080E−05 | 3.97660E−06 | −6.18050E−08 | −3.49580E−09 |
| R5 | −7.18636E+00 | −3.94090E−06 | −5.09730E−06 | 6.85310E−07 | −2.89860E−08 |
| R6 | 1.99000E+02 | 1.82880E−04 | −1.80170E−05 | 1.10680E−06 | −3.13580E−08 |
| R7 | 1.52890E+00 | −1.56610E−04 | 4.72710E−05 | −5.31690E−06 | 2.26940E−07 |
| R8 | −1.12153E−02 | −7.05740E−04 | 1.63910E−04 | −1.99120E−05 | 1.00970E−06 |
| R9 | 1.61771E+00 | 2.15080E−04 | −4.54830E−05 | 5.20350E−06 | −2.48010E−07 |
| R10 | 1.10416E+01 | 1.36090E−05 | −6.58730E−07 | −8.17420E−09 | 1.67630E−09 |
| R11 | 4.70635E+00 | 1.22790E−05 | −8.88520E−07 | 3.71480E−08 | −6.78390E−10 |
| R12 | −2.54116E+01 | −3.23910E−06 | 2.44460E−07 | −1.03380E−08 | 1.85850E−10 |

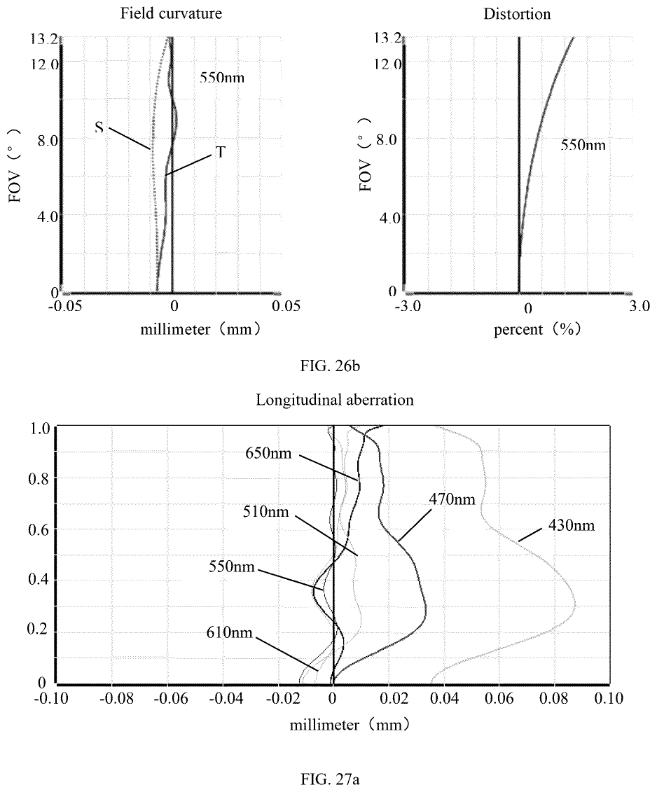

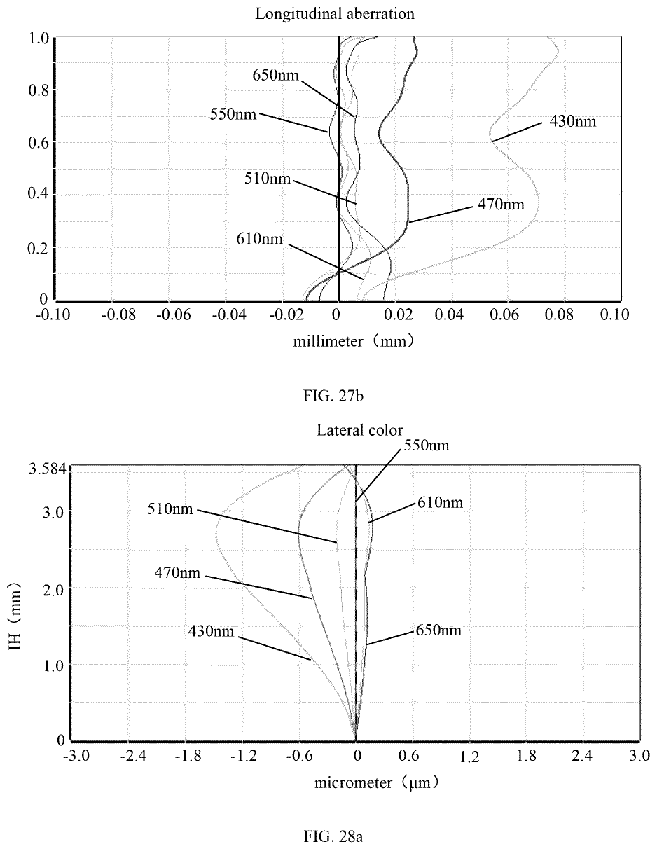

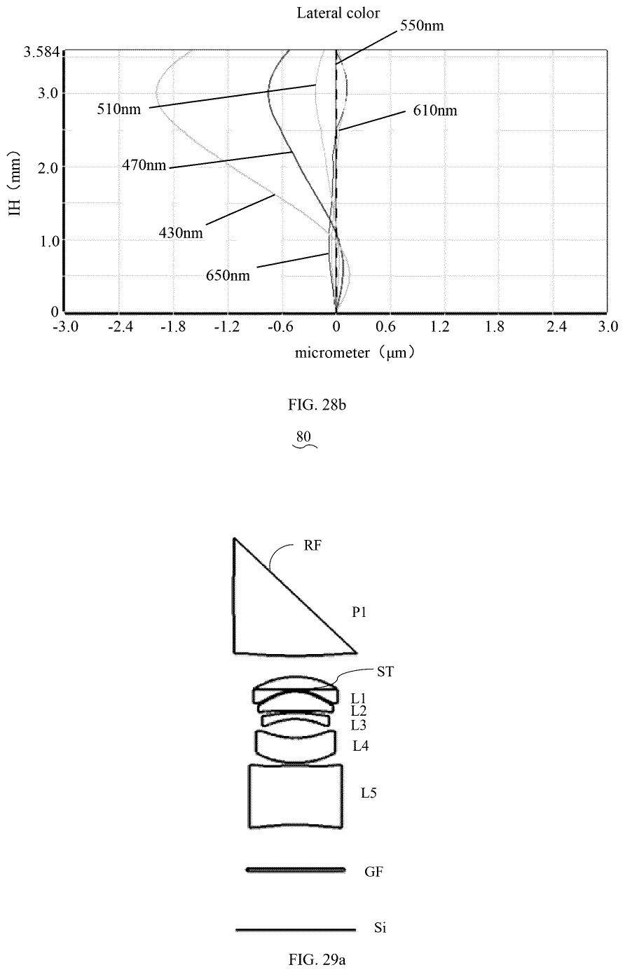

FIG. 26a and FIG. 26b show the field curvature and distortion schematic diagrams after light with a wavelength of 550 nm passes the camera optical lens 70 of the seventh embodiment. FIG. 27a and FIG. 27b show the longitudinal aberration schematic diagrams after light with a wavelength of 430 nm, 470 nm, 510 nm, 550 nm, 610 nm and 650 nm passes the camera optical lens 70 of the seventh embodiment. FIG. 28a and FIG. 28b show the lateral color schematic diagrams after light with a wavelength of 430 nm, 470 nm, 510 nm, 550 nm, 610 nm and 650 nm passes the camera optical lens 70 of the seventh embodiment.

In this embodiment, the entrance pupil diameter (ENPD) of the camera optical lens 70 in the first state is 5.602 mm, the full field image height (IH) is 3.584 mm, and the field of view (FOV) is 26.66°. The camera optical lens 70 enables a large-aperture periscope design, exhibiting superior optical performance with sufficiently corrected on-axis and off-axis chromatic aberrations, and possesses excellent optical characteristics.

### Embodiment 8

The first prism P1 has a positive refractive power, with its object side surface convex in the paraxial region and its image side surface convex in the paraxial region;

The first lens L1 has a negative refractive power, with its object side surface convex in the paraxial region and its image side surface concave in the paraxial region;

The second lens L2 has a positive refractive power, with its object side surface convex in the paraxial region and its image side surface concave in the paraxial region;

The third lens L3 has a negative refractive power, with its object side surface convex in the paraxial region and its image side surface concave in the paraxial region;

The fourth lens L4 has a negative refractive power, with its object side surface concave in the paraxial region and its image side surface convex in the paraxial region;

The fifth lens L5 has a positive refractive power, with its object side surface convex in the paraxial region and its image side surface concave in the paraxial region.

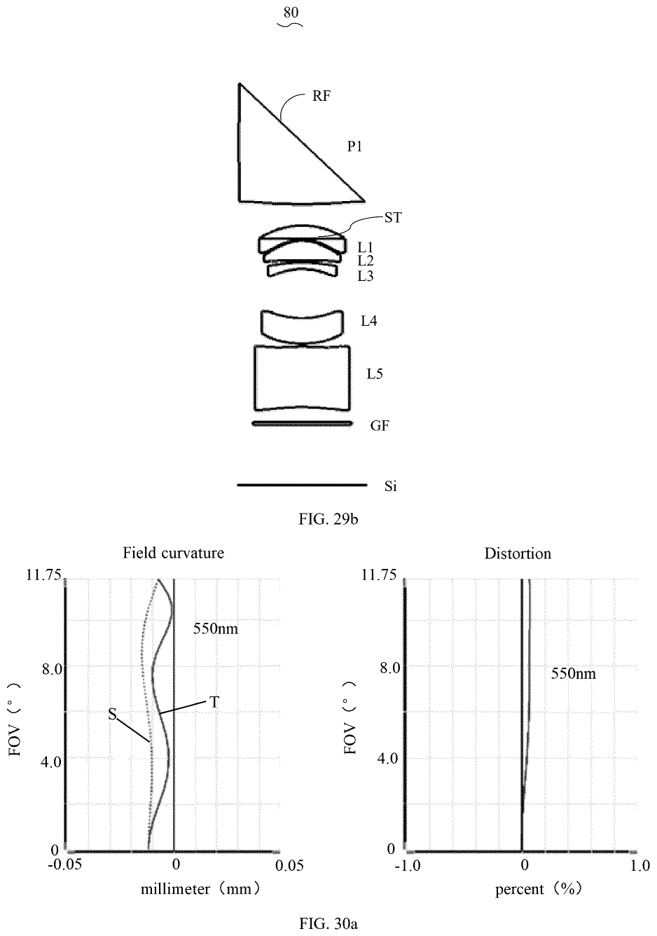

FIGS. 29a and 29b are schematic structural diagrams of the camera optical lens 80 in the eighth embodiment. The symbol meanings in the eighth embodiment are the same as those in the first embodiment.

Table 22 shows the design data of the camera optical lens 80 in the eighth embodiment.

TABLE 22

| | R | d | | nd | | vd | |
|---|---|---|---|---|---|---|---|
| ST | ∞ | d0 | −10.473 | / | / | / | / |
| Rp1 | 134.425 | dp1 | 8.167 | nd1 | 1.5168 | vd1 | 64.17 |
| Rp2 | −34.032 | dp2 | 1.446 | | | | |
| R1 | 4.770 | d1 | 0.918 | nd2 | 1.5444 | vd2 | 55.82 |
| R2 | 2.229 | d2 | 0.087 | | | | |
| R3 | 2.231 | d3 | 1.331 | nd3 | 1.5444 | vd3 | 55.82 |
| R4 | 23.589 | d4 | 0.127 | | | | |
| R5 | 6.128 | d5 | 0.450 | nd4 | 1.6400 | vd4 | 23.54 |
| R6 | 3.818 | d6 | 1.290 | | | | |
| R7 | −4.706 | d7 | 1.700 | nd5 | 1.6610 | vd5 | 20.53 |
| R8 | −7.945 | d8 | 0.200 | | | | |
| R9 | 9.026 | d9 | 4.073 | nd6 | 1.6153 | vd6 | 25.94 |
| R10 | 11.533 | d10 | 3.000 | | | | |
| R11 | ∞ | d11 | 0.210 | ndg | 1.5168 | vdg | 64.17 |
| R12 | ∞ | d12 | 4.057 | | | | |

In which, d1“dp1-01”+“dp1-02”, “dp1-01”=4.021, and “dp1-02”=4.146.

Table 23 shows data of related optical parameters for the camera optical lens 80 according to the eighth embodiment of the present disclosure in a first state and a second state, respectively.

TABLE 23

| | First state | Second state |
|---|---|---|
| fA | 17.203 | 16.215 |
| FOV | 23.50° | 23.02° |
| FNO | 3.00 | 3.35 |
| d6 | 1.290 | 2.148 |
| d10 | 3.000 | 2.142 |

Table 24 shows the conic index and aspherical surface index of the camera optical lens 80.

TABLE 24

| | Conic Index | Aspherical Surface Index | | | | |
|---|---|---|---|---|---|---|
| | k | A4 | A6 | A8 | A10 | A12 |
| R1 | −1.65305E+03 | −8.02500E−05 | −3.04850E−06 | 1.85630E−07 | −6.21050E−09 | −3.06380E−10 |
| R2 | 0.00000E+00 | 0.00000E+00 | 0.00000E+00 | 0.00000E+00 | 0.00000E+00 | 0.00000E+00 |
| R3 | 1.11775E−01 | −1.31680E−03 | 5.33710E−04 | −1.23430E−04 | 2.72660E−05 | −6.88650E−06 |
| R4 | −3.95255E+00 | 1.92530E−03 | −1.97000E−03 | 3.74580E−03 | −1.92200E−03 | 4.73400E−04 |
| R5 | −3.75462E+00 | 1.35980E−03 | −1.76020E−03 | 3.56900E−03 | −1.56310E−03 | 2.68660E−04 |
| R6 | −8.74785E+01 | −3.29940E−02 | 3.37240E−02 | −1.78290E−02 | 5.83940E−03 | −1.25500E−03 |
| R7 | 7.49274E−01 | −3.86900E−02 | 3.68000E−02 | −1.94850E−02 | 5.12350E−03 | −3.67780E−04 |
| R8 | 3.41513E−01 | −1.18170E−02 | 9.83440E−03 | −4.58920E−03 | −5.78830E−04 | 1.52350E−03 |
| R9 | 1.06308E+00 | 4.46020E−03 | 4.37620E−04 | −1.00040E−03 | 1.00160E−03 | −5.92640E−04 |
| R10 | 7.03930E+00 | −2.00550E−02 | 9.34200E−03 | −3.14350E−03 | 7.77270E−04 | −1.29360E−04 |
| R11 | −4.16956E+01 | −1.96170E−02 | 7.81280E−03 | −2.66000E−03 | 6.47490E−04 | −1.09270E−04 |
| R12 | −4.96493E+01 | 1.54160E−03 | −1.10150E−03 | 4.46230E−04 | −1.36410E−04 | 2.75140E−05 |

| | Conic Index | Aspherical Surface Index | | | |
|---|---|---|---|---|---|
| | k | A14 | A16 | A18 | A20 |
| R1 | −1.65305E+03 | 2.97520E−11 | 7.00280E−13 | −1.19950E−13 | 2.90040E−15 |
| R2 | 0.00000E+00 | 0.00000E+00 | 0.00000E+00 | 0.00000E+00 | 0.00000E+00 |
| R3 | 1.11775E−01 | 1.50980E−06 | −2.16720E−07 | 1.70990E−08 | −5.72150E−10 |
| R4 | −3.95255E+00 | −6.22210E−05 | 3.94430E−06 | −6.47000E−08 | −2.54130E−09 |
| R5 | −3.75462E+00 | −3.99270E−06 | −5.12130E−06 | 6.88070E−07 | −2.89260E−08 |
| R6 | −8.74785E+01 | 1.82970E−04 | −1.79950E−05 | 1.10650E−06 | −3.14980E−08 |
| R7 | 7.49274E−01 | −1.56600E−04 | 4.73360E−05 | −5.30880E−06 | 2.24890E−07 |
| R8 | 3.41513E−01 | −7.11070E−04 | 1.64140E−04 | −1.94960E−05 | 9.53150E−07 |
| R9 | 1.06308E+00 | 2.13160E−04 | −4.57140E−05 | 5.37310E−06 | −2.66110E−07 |
| R10 | 7.03930E+00 | 1.31980E−05 | −6.37110E−07 | −3.15490E−09 | 1.18790E−09 |
| R11 | −4.16956E+01 | 1.23100E−05 | −8.83000E−07 | 3.83710E−08 | −8.85000E−10 |
| R12 | −4.96493E+01 | −3.42320E−06 | 2.42790E−07 | −8.25100E−09 | 7.56100E−11 |

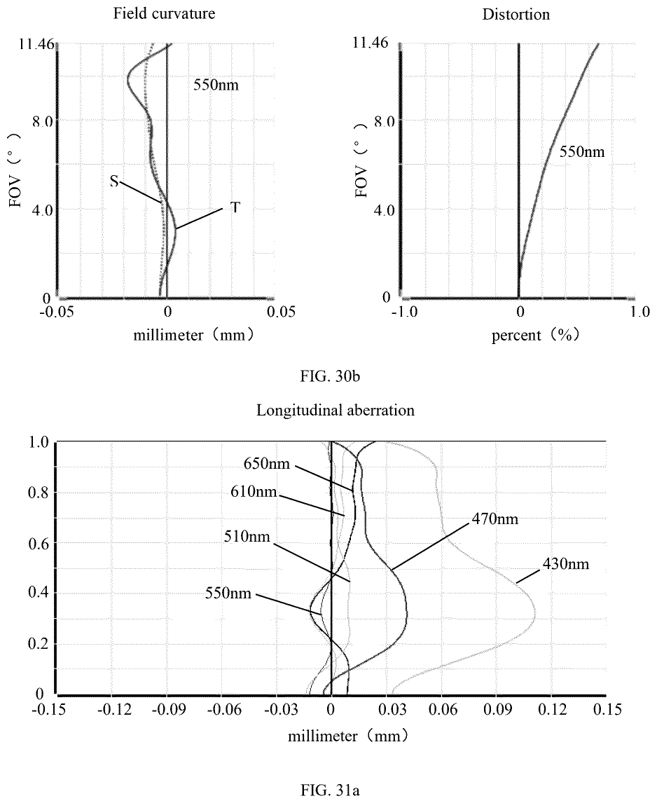

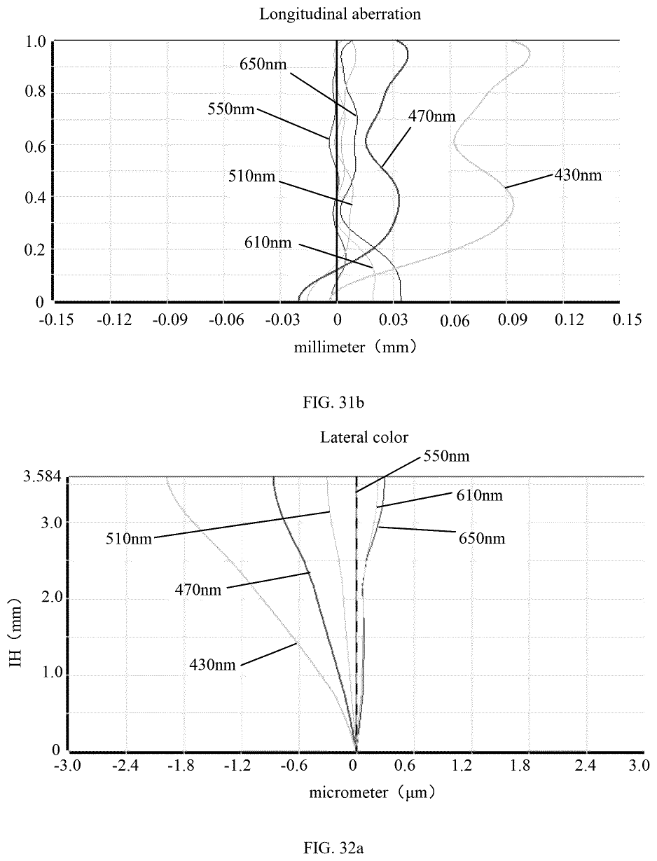

FIG. 30a and FIG. 30b show the field curvature and distortion schematic diagrams after light with a wavelength of 550 nm passes the camera optical lens 80 of the eighth embodiment. FIG. 31a and FIG. 31b show the longitudinal aberration schematic diagrams after light with a wavelength of 430 nm, 470 nm, 510 nm, 550 nm, 610 and 650 nm passes the camera optical lens 80 of the eighth embodiment. FIG. 32a and FIG. 32b show the lateral color schematic diagrams after light with a wavelength of 430 nm, 470 nm, 510 nm, 550 nm, 610 and 650 nm passes the camera optical lens 80 of the eighth embodiment.

In this embodiment, the entrance pupil diameter (ENPD) of the camera optical lens 80 in the first state is 5.722 mm, the full field image height (IH) is 3.584 mm, and the field of view (FOV) is 23.50°. The camera optical lens 80 enables a large-aperture periscope design, exhibiting superior optical performance with sufficiently corrected on-axis and off-axis chromatic aberrations, and possesses excellent optical characteristics.

### Embodiment 9

The first prism P1 has a positive refractive power, with its object side surface convex in the paraxial region and its image side surface convex in the paraxial region;

The first lens L1 has a negative refractive power, with its object side surface convex in the paraxial region and its image side surface concave in the paraxial region;

The second lens L2 has a positive refractive power, with its object side surface convex in the paraxial region and its image side surface concave in the paraxial region;

The third lens L3 has a negative refractive power, with its object side surface convex in the paraxial region and its image side surface concave in the paraxial region;

The fourth lens L4 has a negative refractive power, with its object side surface concave in the paraxial region and its image side surface convex in the paraxial region;

The fifth lens L5 has a positive refractive power, with its object side surface convex in the paraxial region and its image side surface concave in the paraxial region.

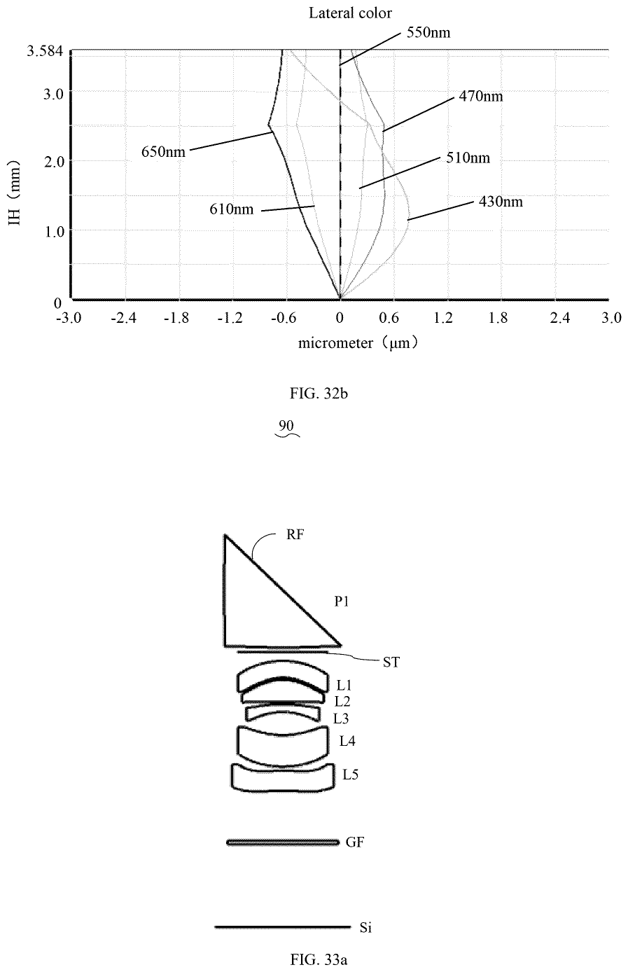

FIGS. 33a and 33b are schematic structural diagrams of the camera optical lens 90 in the ninth embodiment. The symbol meanings in the ninth embodiment are the same as those in the first embodiment.

Table 25 shows the design data of the camera optical lens 90 in the ninth embodiment.

TABLE 25

| | R | d | | nd | | vd | |
|---|---|---|---|---|---|---|---|
| ST | ∞ | d0 | −7.014 | / | / | / | / |
| Rp1 | 137.324 | dp1 | 6.730 | nd1 | 1.5168 | vd1 | 64.17 |
| Rp2 | −47.356 | dp2 | 0.800 | | | | |
| R1 | 4.356 | d1 | 0.990 | nd2 | 1.5444 | vd2 | 55.82 |
| R2 | 2.274 | d2 | 0.120 | | | | |
| R3 | 2.239 | d3 | 1.333 | nd3 | 1.5444 | vd3 | 55.82 |
| R4 | 43.166 | d4 | 0.129 | | | | |
| R5 | 5.897 | d5 | 0.466 | nd4 | 1.6400 | vd4 | 23.54 |
| R6 | 3.316 | d6 | 1.386 | | | | |
| R7 | −4.152 | d7 | 1.870 | nd5 | 1.6610 | vd5 | 20.53 |
| R8 | −5.834 | d8 | 0.243 | | | | |
| R9 | 7.939 | d9 | 1.185 | nd6 | 1.6153 | vd6 | 25.94 |
| R10 | 8.601 | d10 | 3.000 | | | | |
| R11 | ∞ | d11 | 0.210 | ndg | 1.5168 | vdg | 64.17 |
| R12 | ∞ | d12 | 4.934 | | | | |

In which, d1=“dp1-01”+“dp1-02”, “dp1-01”=3.337, and “dp1-02”=3.393.

Table 26 shows data of related optical parameters for the camera optical lens 90 according to the ninth embodiment of the present disclosure in a first state and a second state, respectively.

TABLE 23

| | First state | Second state |
|---|---|---|
| fA | 15.770 | 14.750 |
| FOV | 25.58° | 24.86° |
| FNO | 3.00 | 3.25 |
| d6 | 1.386 | 2.169 |
| d10 | 3.000 | 2.217 |

Table 27 shows the conic index and aspherical surface index of the camera optical lens 90.

TABLE 24

| | Conic Index | Aspherical Surface Index | | | | |
|---|---|---|---|---|---|---|
| | k | A4 | A6 | A8 | A10 | A12 |
| R1 | −2.30413E+03 | −1.14120E−04 | −4.07570E−06 | 4.05330E−07 | −2.23680E−08 | −1.89710E−10 |
| R2 | 0.00000E+00 | 0.00000E+00 | 0.00000E+00 | 0.00000E+00 | 0.00000E+00 | 0.00000E+00 |
| R3 | 7.48499E−02 | −1.43270E−03 | 6.14600E−04 | −1.27930E−04 | 2.65400E−05 | −6.85860E−06 |
| R4 | −4.18874E+00 | 2.29320E−03 | −2.04080E−03 | 3.74870E−03 | −1.92190E−03 | 4.73870E−04 |
| R5 | −3.74671E+00 | 1.10310E−03 | −1.80080E−03 | 3.54770E−03 | −1.56680E−03 | 2.67440E−04 |
| R6 | −1.98995E+02 | −3.24360E−02 | 3.32490E−02 | −1.78260E−02 | 5.84070E−03 | −1.25410E−03 |
| R7 | 5.66998E−01 | −3.87240E−02 | 3.63220E−02 | −1.94800E−02 | 5.16950E−03 | −3.76630E−04 |
| R8 | 1.50185E−01 | −1.31230E−02 | 9.56690E−03 | −4.45960E−03 | −5.81250E−04 | 1.51940E−03 |
| R9 | 4.27406E−01 | 8.83510E−03 | −3.67180E−04 | −7.66080E−04 | 9.70780E−04 | −5.96650E−04 |
| R10 | 2.18826E+00 | −1.61880E−02 | 8.90240E−03 | −3.10550E−03 | 7.74950E−04 | −1.30920E−04 |
| R11 | −1.83437E+01 | −3.21910E−02 | 8.62860E−03 | −2.65650E−03 | 6.26340E−04 | −1.09860E−04 |
| R12 | −2.59980E+01 | −1.14590E−02 | 1.61230E−04 | 3.74290E−04 | −1.43300E−04 | 2.84460E−05 |

| | Conic Index | Aspherical Surface Index | | | |
|---|---|---|---|---|---|
| | k | A14 | A16 | A18 | A20 |
| R1 | −2.30413E+03 | 1.14110E−10 | −1.84060E−12 | −4.56660E−13 | 2.00970E−14 |
| R2 | 0.00000E+00 | 0.00000E+00 | 0.00000E+00 | 0.00000E+00 | 0.00000E+00 |
| R3 | 7.48499E−02 | 1.50580E−06 | −2.15220E−07 | 1.71310E−08 | −6.00130E−10 |
| R4 | −4.18874E+00 | −6.24220E−05 | 3.95220E−06 | −6.31900E−08 | −2.61120E−09 |
| R5 | −3.74671E+00 | −3.67730E−06 | −5.12610E−06 | 6.87030E−07 | −2.88750E−08 |
| R6 | −1.98995E+02 | 1.82910E−04 | −1.79880E−05 | 1.10710E−06 | −3.18510E−08 |
| R7 | 5.66998E−01 | −1.56370E−04 | 4.73980E−05 | −5.30210E−06 | 2.22690E−07 |
| R8 | 1.50185E−01 | −7.12730E−04 | 1.64370E−04 | −1.93610E−05 | 9.30550E−07 |
| R9 | 4.27406E−01 | 2.14070E−04 | −4.56070E−05 | 5.36120E−06 | −2.67620E−07 |
| R10 | 2.18826E+00 | 1.32280E−05 | −6.21470E−07 | 2.57060E−09 | 4.08940E−10 |
| R11 | −1.83437E+01 | 1.27130E−05 | −8.75040E−07 | 3.45870E−08 | −6.96990E−10 |
| R12 | −2.59980E+01 | −3.36030E−06 | 2.31650E−07 | −8.15500E−09 | 1.01020E−10 |

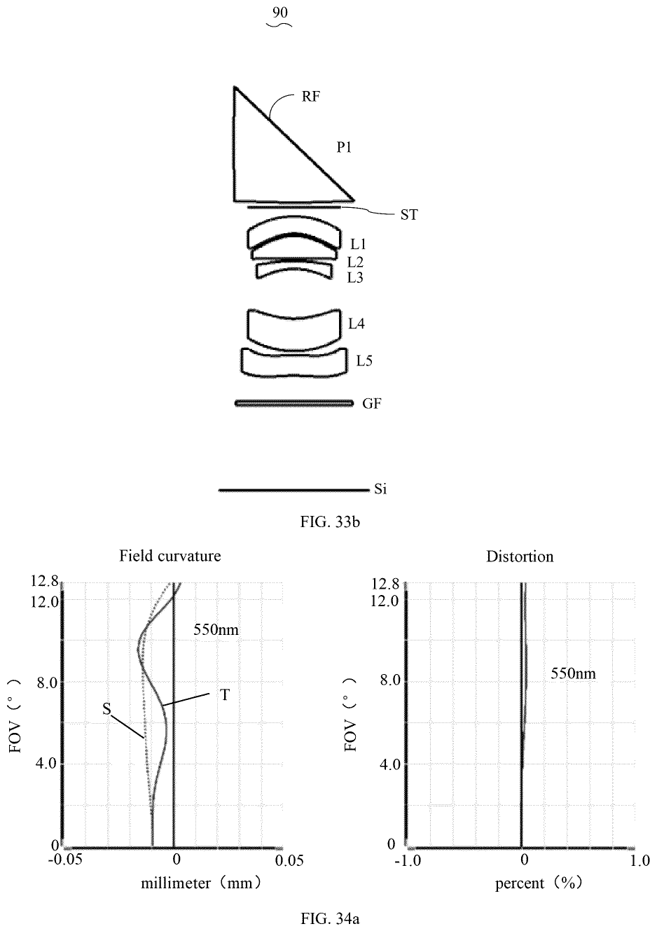

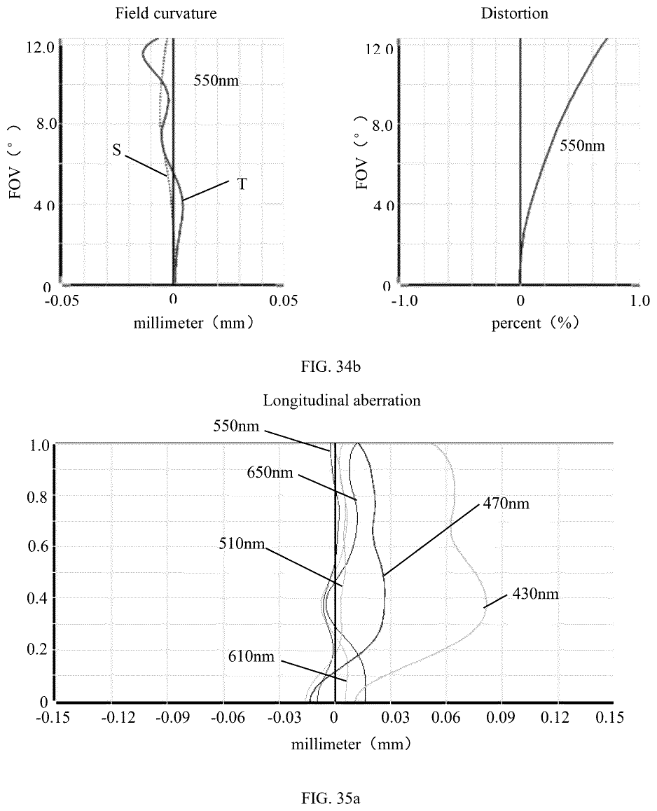

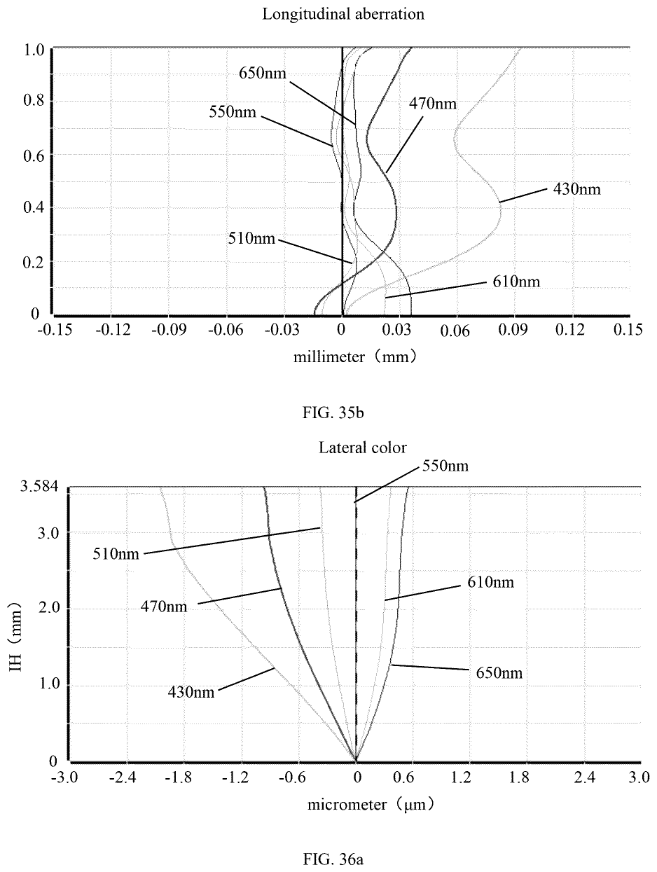

FIG. 34a and FIG. 34b show the field curvature and distortion schematic diagrams after light with a wavelength of 550 nm passes the camera optical lens 90 of the ninth embodiment. FIG. 35a and FIG. 35b show the longitudinal aberration schematic diagrams after light with a wavelength of 430 nm, 470 nm, 510 nm, 550 nm, 610 and 650 nm passes the camera optical lens 90 of the ninth embodiment. FIG. 36a and FIG. 36b show the lateral color schematic diagrams after light with a wavelength of 430 nm, 470 nm, 510 nm, 550 nm, 610 and 650 nm passes the camera optical lens 90 of the ninth embodiment.

In this embodiment, the entrance pupil diameter (ENPD) of the camera optical lens 90 in the first state is 5.245 mm, the full field image height (IH) is 3.584 mm, and the field of view (FOV) is 25.58°. The camera optical lens 90 enables a large-aperture periscope design, exhibiting superior optical performance with sufficiently corrected on-axis and off-axis chromatic aberrations, and possesses excellent optical characteristics.

### Embodiment 10

The first prism P1 has a positive refractive power, with its object side surface planar in the paraxial region and its image side surface planar in the paraxial region;

The first lens L1 has a negative refractive power, with its object side surface convex in the paraxial region and its image side surface concave in the paraxial region;

The second lens L2 has a positive refractive power, with its object side surface convex in the paraxial region and its image side surface concave in the paraxial region;

The third lens L3 has a negative refractive power, with its object side surface convex in the paraxial region and its image side surface concave in the paraxial region;

The fourth lens L4 has a negative refractive power, with its object side surface concave in the paraxial region and its image side surface convex in the paraxial region;

The fifth lens L5 has a positive refractive power, with its object side surface convex in the paraxial region and its image side surface concave in the paraxial region.

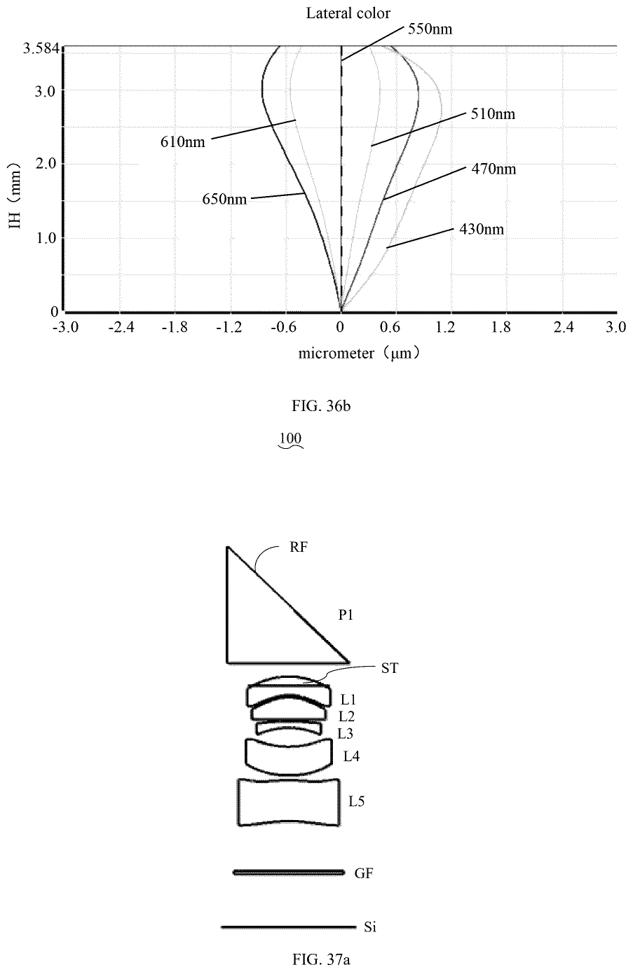

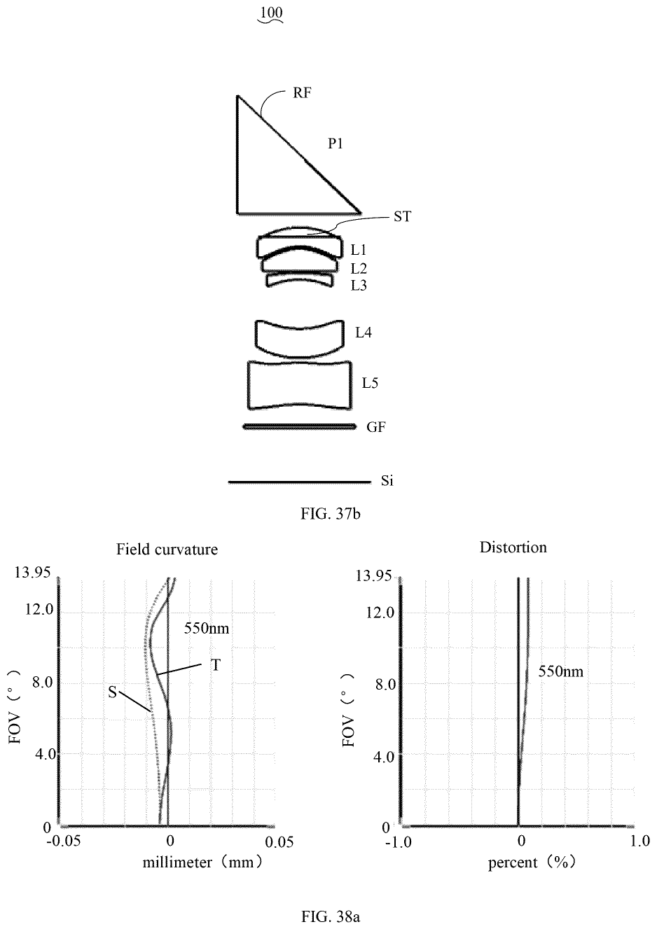

FIGS. 37a and 37b are schematic structural diagrams of the camera optical lens 100 in the tenth embodiment. The symbol meanings in the tenth embodiment are the same as those in the first embodiment.

Table 28 shows the design data of the camera optical lens 100 in the tenth embodiment.

TABLE 28

| | R | d | | nd | | vd | |
|---|---|---|---|---|---|---|---|
| ST | ∞ | d0 | −8.445 | / | / | / | / |
| Rp1 | 280.145 | dp1 | 7.098 | nd1 | 1.5168 | vd1 | 64.17 |
| Rp2 | −229.705 | dp2 | 0.800 | | | | |
| R1 | 4.189 | d1 | 1.122 | nd2 | 1.5444 | vd2 | 55.82 |
| R2 | 2.374 | d2 | 0.130 | | | | |
| R3 | 2.297 | d3 | 1.343 | nd3 | 1.5444 | vd3 | 55.82 |
| R4 | 97.383 | d4 | 0.106 | | | | |
| R5 | 7.217 | d5 | 0.400 | nd4 | 1.6400 | vd4 | 23.54 |
| R6 | 3.745 | d6 | 1.144 | | | | |
| R7 | −4.695 | d7 | 1.729 | nd5 | 1.6610 | vd5 | 20.53 |
| R8 | −7.207 | d8 | 0.301 | | | | |
| R9 | 6.761 | d9 | 2.477 | nd6 | 1.6153 | vd6 | 25.94 |
| R10 | 6.991 | d10 | 3.000 | | | | |
| R11 | ∞ | d11 | 0.210 | ndg | 1.5168 | vdg | 64.17 |
| R12 | ∞ | d12 | 3.221 | | | | |

In which, d1=“dp1-01”+“dp1-02”, “dp1-01”=3.542, and “dp1-02”=3.556.

Table 29 shows data of related optical parameters for the camera optical lens 100 according to the tenth embodiment of the present disclosure in a first state and a second state, respectively.

TABLE 29

| | First state | Second state |
|---|---|---|
| fA | 14.408 | 13.620 |
| FOV | 27.91° | 27.16° |
| FNO | 3.00 | 3.37 |
| d6 | 1.144 | 2.136 |
| d10 | 3.000 | 2.008 |

Table 30 shows the conic index and aspherical surface index of the camera optical lens 100.

TABLE 30

| | Conic Index | Aspherical Surface Index | | | | |
|---|---|---|---|---|---|---|
| | k | A4 | A6 | A8 | A10 | A12 |
| R1 | −1.29997E+04 | −1.46010E−04 | −5.39890E−06 | 7.66630E−07 | −3.58640E−08 | −2.17990E−09 |
| R2 | 0.00000E+00 | 0.00000E+00 | 0.00000E+00 | 0.00000E+00 | 0.00000E+00 | 0.00000E+00 |
| R3 | 1.25890E−01 | −1.19560E−03 | 6.22310E−04 | −1.43560E−04 | 2.62340E−05 | −6.82600E−06 |
| R4 | −5.08573E+00 | 3.62670E−03 | −2.00490E−03 | 3.68490E−03 | −1.93720E−03 | 4.71250E−04 |
| R5 | −4.34722E+00 | 2.03050E−03 | −1.63690E−03 | 3.54490E−03 | −1.58060E−03 | 2.65980E−04 |
| R6 | 1.99000E+02 | −3.14900E−02 | 3.26000E−02 | −1.76740E−02 | 5.83560E−03 | −1.25030E−03 |
| R7 | 3.47110E+00 | −3.64540E−02 | 3.45710E−02 | −1.95920E−02 | 5.29980E−03 | −3.94780E−04 |
| R8 | 4.43523E−01 | −1.00640E−02 | 7.81610E−03 | −4.22700E−03 | −5.76600E−04 | 1.51890E−03 |
| R9 | 1.81131E+00 | 4.96010E−03 | 5.13050E−04 | −9.75520E−04 | 1.00450E−03 | −5.97320E−04 |
| R10 | 2.96666E+00 | −2.28050E−02 | 9.57380E−03 | −3.12530E−03 | 7.58280E−04 | −1.25810E−04 |
| R11 | −1.05015E+01 | −2.73630E−02 | 8.92050E−03 | −2.73390E−03 | 6.46780E−04 | −1.10220E−04 |
| R12 | −1.80338E+01 | −1.06760E−03 | −1.00330E−03 | 4.63370E−04 | −1.37870E−04 | 2.70880E−05 |

| | Conic Index | Aspherical Surface Index | | | |
|---|---|---|---|---|---|
| | k | A14 | A16 | A18 | A20 |
| R1 | −1.29997E+04 | 2.62880E−10 | 5.95800E−12 | −1.52790E−12 | 4.84490E−14 |
| R2 | 0.00000E+00 | 0.00000E+00 | 0.00000E+00 | 0.00000E+00 | 0.00000E+00 |
| R3 | 1.25890E−01 | 1.50230E−06 | −2.12690E−07 | 1.61900E−08 | −5.52820E−10 |
| R4 | −5.08573E+00 | −6.15670E−05 | 3.94500E−06 | −6.42530E−08 | −2.63070E−09 |
| R5 | −4.34722E+00 | −2.91880E−06 | −5.11860E−06 | 6.87740E−07 | −2.90330E−08 |
| R6 | 1.99000E+02 | 1.82620E−04 | −1.79830E−05 | 1.10830E−06 | −3.16030E−08 |
| R7 | 3.47110E+00 | −1.56450E−04 | 4.74000E−05 | −5.29960E−06 | 2.23320E−07 |
| R8 | 4.43523E−01 | −7.13490E−04 | 1.64230E−04 | −1.93440E−05 | 9.37610E−07 |
| R9 | 1.81131E+00 | 2.14330E−04 | −4.56710E−05 | 5.32730E−06 | −2.61450E−07 |
| R10 | 2.96666E+00 | 1.27270E−05 | −6.28010E−07 | 3.53470E−09 | 5.32220E−10 |
| R11 | −1.05015E+01 | 1.25650E−05 | −8.80820E−07 | 3.42900E−08 | −6.28830E−10 |
| R12 | −1.80338E+01 | −3.35660E−06 | 2.42380E−07 | −8.60960E−09 | 8.96530E−11 |

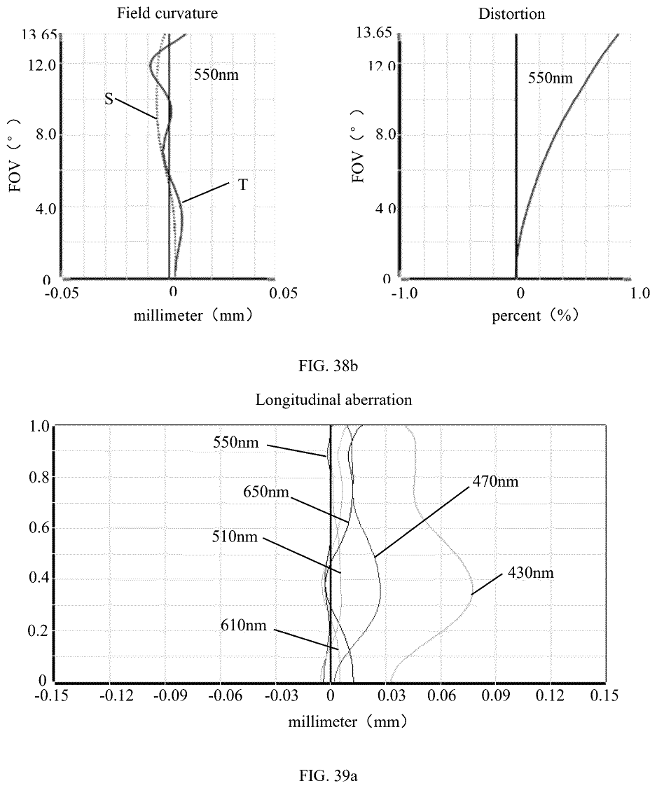

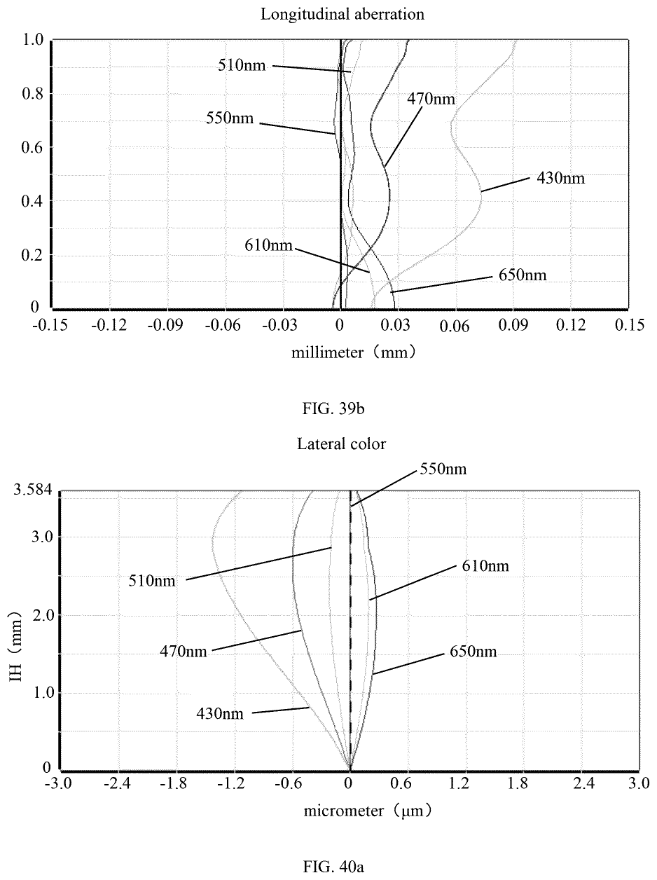

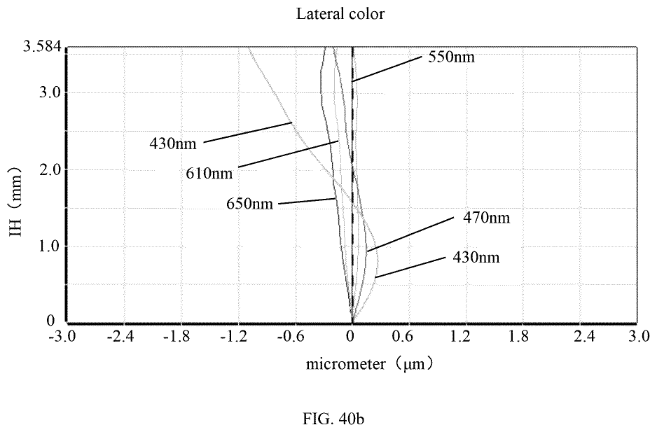

FIG. 38a and FIG. 38b show the field curvature and distortion schematic diagrams after light with a wavelength of 550 nm passes the camera optical lens 100 of the tenth embodiment. FIG. 39a and FIG. 39b show the longitudinal aberration schematic diagrams after light with a wavelength of 430 nm, 470 nm, 510 nm, 550 nm, 610 and 650 nm passes the camera optical lens 100 of the tenth embodiment. FIG. 40a and FIG. 40b show the lateral color schematic diagrams after light with a wavelength of 430 nm, 470 nm, 510 nm, 550 nm, 610 and 650 nm passes the camera optical lens 100 of the tenth embodiment.

In this embodiment, the entrance pupil diameter (ENPD) of the camera optical lens 100 in the first state is 4.792 mm, the full field image height (H) is 3.584 mm, and the field of view (FOV) is 27.910. The camera optical lens 100 enables a large-aperture periscope design, exhibiting superior optical performance with sufficiently corrected on-axis and off-axis chromatic aberrations, and possesses excellent optical characteristics.

Subsequent Table 31 lists the values corresponding to specified parameters in the conditional expressions for each of Embodiments 1, 2, 3, 4, 5, 6, 7, 8, 9 and 10.

TABLE 31

| Parameters and | | | | |
|---|---|---|---|---|
| Conditional | Embodi- | Embodi- | Embodi- | Embodi- |
| Expressions | ment 1 | ment 2 | ment 3 | ment 4 |
| fA/IH | 4.05 | 4.67 | 4.05 | 4.06 |
| Rp1/Rp2 | 0.01 | 0.35 | 0.66 | 0.72 |
| f1/fA | 0.70 | 0.52 | 0.86 | 0.82 |
| BF/TTL | 0.17 | 0.25 | 0.12 | 0.21 |
| f4/f5 | −5.37 | −3.33 | −15.62 | −8.27 |
| fA | 14.500 | 16.737 | 14.500 | 14.535 |
| fp1 | 97.222 | 123.538 | 209.548 | 63.989 |
| f1 | 10.144 | 8.703 | 12.471 | 11.919 |
| f2 | −9.865 | −9.210 | −11.287 | −11.362 |
| f3 | 10.370 | 16.370 | 8.342 | 8.617 |
| f4 | 50.269 | 36.521 | 147.562 | 69.632 |
| f5 | −9.355 | −10.979 | −9.448 | −8.424 |
| TTL | 26.184 | 25.506 | 27.633 | 20.972 |
| Parameters and | | | | |
| Conditional | Embodi- | Embodi- | Embodi- | Embodi- |
| Expressions | ment 5 | ment 6 | ment 7 | ment 8 |
| fA/IH | 4.05 | 4.01 | 4.20 | 4.80 |
| Rp1/Rp2 | 1.10 | −0.70 | −1.17 | −3.95 |
| f1/fA | 1.00 | −1.40 | −1.76 | −0.51 |
| BF/TTL | 0.25 | 0.28 | 0.20 | 0.27 |
| f4/f5 | 12.14 | 0.43 | −0.17 | −0.53 |
| fA | 14.500 | 14.372 | 15.053 | 17.203 |
| fp1 | 591.176 | 284.826 | 117.027 | 53.255 |
| f1 | 14.500 | −20.121 | −26.493 | −8.774 |
| f2 | −15.523 | 4.729 | 5.554 | 4.411 |
| f3 | 8.686 | −11.365 | −13.354 | −16.989 |
| f4 | −146.737 | −78.028 | −30.368 | −21.882 |
| f5 | −12.083 | −180.933 | 182.140 | 41.273 |
| TTL | 20.044 | 23.435 | 26.609 | 27.056 |

| Parameters and | | | | |
|---|---|---|---|---|
| Conditional | Embodi- | Embodi- | | |
| Expressions | ment 9 | ment 10 | / | / |
| fA/IH | 4.40 | 4.02 | / | / |
| Rp1/Rp2 | −2.90 | −1.22 | / | / |
| f1/fA | −0.66 | −0.89 | / | / |
| BF/TTL | 0.35 | 0.28 | / | / |
| f4/f5 | −0.39 | −0.43 | / | / |
| fA | 15.770 | 14.408 | / | / |
| fp1 | 68.766 | 244.575 | / | / |
| f1 | −10.465 | −12.823 | / | / |
| f2 | 4.272 | 4.284 | / | / |
| f3 | −12.626 | −12.627 | / | / |
| f4 | −38.890 | −27.847 | / | / |
| f5 | 98.700 | 64.670 | / | / |
| TTL | 23.396 | 23.081 | / | / |

The camera optical lenses provided in the embodiments of the present disclosure have been described in detail above. Specific examples are used in this document to elaborate on the principles and embodiments of the disclosure, and the descriptions of these embodiments are intended solely to facilitate understanding of the inventive concept. Modifications and variations may occur in specific embodiments and application scopes. In summary, the content of this specification should not be construed as limitations to the present invention.

What is claimed is:

1. A camera optical lens comprising, in an order from an object side to an image side in sequence: a first prism with a positive refractive power, a first lens, a second lens, a third lens, a fourth lens, and a fifth lens; wherein a reflective surface is disposed between the object side surface and the image side surface of the first prism, the first lens, the second lens, and the third lens are defined as a first lens group, while the fourth lens and the fifth lens are defined as a second lens group, the second lens group is adjustably movable along the optical axis of the camera optical lens to switch the camera optical lens between a first state and a second state, the camera optical lens achieves its maximum focal length in the first state, and achieves its minimum focal length in the second state; and the camera optical lens further satisfies the following conditions:
$$4. \leq fA / IH \leq 4.8 ;$$
$$- 4. 0 \leq Rp 1 / Rp 2 \leq 1.2 ;$$
$$- 1.76 \leq f 1 / fA \leq 1. ;$$
$$0.12 \leq BF / TTL \leq 0 \text{.35} ;$$
where
fA: the focal length of the camera optical lens in the first state;
IH: the image height of the camera optical lens;
Rp1: the curvature radius of the object side surface of the first prism;
Rp2: the curvature radius of the image side surface of the first prism;
f1: the focal length of the first lens;
BF: the back focal length of the camera optical lens;
TTL: the total optical length of the camera optical lens.

2. The camera optical lens as described in claim 1 further satisfies the following condition:
$$- 16.00 \leq f 4 / f 5 \leq 13. ;$$
where
f4: the focal length of the fourth lens;
f5: the focal length of the fifth lens.

3. The camera optical lens as described in claim 1, wherein an object side surface of the first lens is convex in the paraxial region, and the camera optical lens further satisfies the following conditions:
$$3.09 \leq fp 1 / fA \leq 40.78 ;$$
$$0.28 \leq dp 1 / TTL \leq 0 \text{.38} ;$$
where
fp1: the focal length of the first prism;
dp1: the sum of the distance on-axis from the object side surface of the first prism to the reflective surface, and the distance on-axis from the reflective surface to the image side surface of the first prism.

4. The camera optical lens as described in claim 1, wherein an object side surface of the first lens is convex in the paraxial region, and the camera optical lens further satisfies the following conditions:
$$- 2.72 \leq ( R 1 + R 2 ) / ( R 1 - R 2 ) \leq 5.45 ;$$
$$0.03 \leq d 1 / TTL \leq 0 \text{.14} ;$$
where
R1: the curvature radius of the object side surface of the first lens;
R2: the curvature radius of the image side surface of the first lens;
d1: the thickness on-axis of the first lens.

5. The camera optical lens as described in claim 1, wherein an object side surface of the second lens is convex in the paraxial region, and the camera optical lens further satisfies the following conditions:
$$- 1.21 \leq ( R 3 + R 4 ) / ( R 3 - R 4 ) \leq 4.65 ;$$
$$- 1.08 \leq f 2 / fA \leq 0.37 ;$$
$$0.01 \leq d 3 / TTL \leq 0 \text{.07} ;$$
where
R3: the curvature radius of the object side surface of the second lens;
R4: the curvature radius of the image side surface of the second lens;
f2: the focal length of the second lens;
d3: the thickness on-axis of the second lens.

6. The camera optical lens as described in claim 1, wherein an object side surface of the third lens is convex in the paraxial region, and the camera optical lens further satisfies the following conditions:
$$- 2.27 \leq ( R 5 + R 6 ) / ( R 5 - R 6 ) \leq 4.31 ;$$
$$- 0.9 \; 9 \leq f 3 / fA \leq 0.98 ;$$
$$0.01 \leq d 5 / TTL \leq 0 \text{.08} ;$$
where
R5: the curvature radius of the object side surface of the third lens;
R6: the curvature radius of the image side surface of the third lens;
f3: the focal length of the third lens;
d5: the thickness on-axis of the third lens.

7. The camera optical lens as described in claim 1, wherein an object side surface of the fourth lens is concave in the paraxial region, an image side surface of the fourth lens is convex in the paraxial region, and the camera optical lens further satisfies the following conditions:
$$- 7.49 \leq ( R 7 + R 8 ) / ( R 7 - R 8 ) \leq 1 27.2 ;$$
$$- 10. 12 \leq f 4 / fA \leq 10 \text{.18} ;$$
$$0.06 \leq d 7 / TTL \leq 0 \text{.15} ;$$
where
R7: the curvature radius of the object side surface of the fourth lens;
R8: the curvature radius of the image side surface of the fourth lens;
f4: the focal length of the fourth lens;
d7: the thickness on-axis of the fourth lens.

8. The camera optical lens as described in claim 1, wherein an object side surface of the fifth lens is convex in the paraxial region, an image side surface of the fourth lens is concave in the paraxial region, and the camera optical lens further satisfies the following conditions:
$$- 59. 80 \leq ( R 9 + R 10 ) / ( R 9 - R 10 ) \leq 19.69 ;$$
$$- 12. 59 \leq f 5 / fA \leq 12 \text{.10} ;$$
$$0.02 \leq d 9 / TTL \leq 0 \text{.16} ;$$
where
R9: the curvature radius of the object side surface of the fifth lens;
R10: the curvature radius of the image side surface of the fifth lens;
f5: the focal length of the fifth lens;
d9: the thickness on-axis of the fifth lens.

9. The camera optical lens as described in claim 1, wherein the first prism is made of glass material.
